(19) United States
(12) Patent Application Publication
(10) Pub. No.: US 2018/0285816 A1
(43) Pub. Date: Oct. 4, 2018

(54) APPARATUS TO ADMINISTER RULE-BASED ALLOCATION OF UNSOLD RESOURCES

(71) Applicant: Walmart Apollo, LLC, Bentonville, AR (US)

(72) Inventors: Todd D. Mattingly, Bentonville, AR (US); Bruce W. Wilkinson, Rogers, AR (US); Greg N. Vukin, Bentonville, AR (US)

(21) Appl. No.: 15/939,788

(22) Filed: Mar. 29, 2018

Related U.S. Application Data
(60) Provisional application No. 62/479,106, filed on Mar. 30, 2017.
(60) Provisional application No. 62/485,045, filed on Apr. 13, 2017.

(51) Int. Cl. G06Q 10/08; G06Q 30/02

(52) U.S. Cl. CPC G06Q 10/0875; G06Q 30/0201

(57) ABSTRACT

A control circuit accesses mobile analytics information comprising, at least in part, data regarding movement of the user devices (such as but not limited to so-called smart phones). The control circuit uses that data to facilitate allocating unsold resources (such as goods and/or services). By one approach the data regarding movement of the user devices constitutes anonymized information that does not identify specific users. In addition, in lieu of the foregoing or in combination therewith, this data may comprise, at least in part, real-time data regarding movement of the user devices. By one approach the control circuit personalizes the anonymized information to thereby provide data regarding movement of specifically-identified users. In this case that personalized movement information can be leveraged by the control circuit when facilitating the aforementioned allocation of unsold resources.

### RELATED APPLICATION(S)

This application claims the benefit of U.S. Provisional Application No. 62/479,106, filed Mar. 30, 2017 and U.S. Provisional Application No. 62/485,045, filed Apr. 13, 2017, all of which are incorporated herein by reference in their entirety.

### TECHNICAL FIELD

These teachings relate generally to providing products and services to individuals and more particularly to mobile analytics information.

### BACKGROUND

Various shopping paradigms are known in the art. One approach of long-standing use essentially comprises displaying a variety of different goods at a shared physical location and allowing consumers to view/experience those offerings as they wish to thereby make their purchasing selections. This model is being increasingly challenged due at least in part to the logistical and temporal inefficiencies that accompany this approach and also because this approach does not assure that a product best suited to a particular consumer will in fact be available for that consumer to purchase at the time of their visit.

Various branches of mobile analytics are also known in the art. As used herein, “mobile analytics” refers to data representing the location and travel over time of mobile communications devices such as cellular telephony devices (including both voice only, data only, and both voice and data compatible devices) and the analysis of such data. Mobile analytics data can be real-time, near-real time (where the data represents circumstances within at least the past, say, ten seconds, thirty seconds, one minute, or the like), and/or historical scenarios.

Mobile analytics data can be captured, for example, by cellular telephony service providers by recording and aggregating as appropriate the service provider's view of their mobile subscribers as those subscribers move and become attached to or otherwise viewed by various cell towers. In many cases a given customer device is visible to a plurality of antenna towers and the location of the customer device can be reliably ascertained by triangulating that location based, for example, on the relative strength of the device's signal at each of the towers. It is also possible that a customer device may have its own native capability of ascertaining its own location, which location the device transmits to the service provider on a push or pull basis as desired to support any of a variety of services (such as, for example, presence-based services).

Mobile analytics data has been analyzed to identify, for example, cellular towers or other network elements that are relatively overloaded and which need to be upgraded or supplemented to continue to assure a quality customer experience. More recently there have been suggestions that mobile analytics data might be useful to retailers and other non-communications service providers to help with their marketing plans. To date, however, such possibilities remain largely without realization.

In addition, and apart from the foregoing, increasing efforts are also being made to present a given consumer with one or more purchasing options that are selected based upon some preference of the consumer. When done properly, this approach can help to avoid presenting the consumer with things that they might not wish to consider. That said, existing preference-based approaches nevertheless leave much to be desired. Information regarding preferences, for example, may tend to be very product specific and accordingly may have little value apart from use with a very specific product or product category. As a result, while helpful, a preferences-based approach is inherently very limited in scope and offers only a very weak platform by which to assess a wide variety of product and service categories.

### BRIEF DESCRIPTION OF THE DRAWINGS

The above needs are at least partially met through provision of the apparatus to administer rule-based allocation of unsold resources described in the following detailed description, particularly when studied in conjunction with the drawings, wherein:

FIG. 1 comprises a flow diagram as configured in accordance with various embodiments of these teachings;

FIG. 2 a graphic representation as configured in accordance with various embodiments of these teachings;

FIG. 3 comprises a flow diagram as configured in accordance with various embodiments of these teachings;

FIG. 4 comprises a block diagram as configured in accordance with various embodiments of these teachings;

FIG. 5 comprises a flow diagram as configured in accordance with various embodiments of these teachings;

FIG. 6 comprises a flow diagram as configured in accordance with various embodiments of these teachings;

FIG. 7 comprises a graphic representation as configured in accordance with various embodiments of these teachings;

FIG. 8 comprises a graph as configured in accordance with various embodiments of these teachings;

FIG. 9 comprises a flow diagram as configured in accordance with various embodiments of these teachings;

FIG. 10 comprises a graphic representation as configured in accordance with various embodiments of these teachings;

FIG. 11 comprises a graphic representation as configured in accordance with various embodiments of these teachings;

FIG. 12 comprises a graphic representation as configured in accordance with various embodiments of these teachings;

FIG. 13 comprises a flow diagram as configured in accordance with various embodiments of these teachings;

FIG. 14 comprises a graphic representation as configured in accordance with various embodiments of these teachings;

FIG. 15 comprises a graphic representation as configured in accordance with various embodiments of these teachings;

FIG. 16 comprises a block diagram as configured in accordance with various embodiments of these teachings; and

FIG. 17 comprises a block diagram as configured in accordance with various embodiments of these teachings.

### DETAILED DESCRIPTION

Generally speaking, these teachings provide for employing a control circuit configured to access mobile analytics information comprising, at least in part, data regarding movement of the user devices (such as but not limited to so-called smart phones). The control circuit then uses that data to facilitate allocating unsold resources (such as goods and/or services). By one approach the data regarding movement of the user devices constitutes anonymized information that does not identify specific users. In addition, in lieu of the foregoing or in combination therewith, this data may comprise, at least in part, real-time data regarding movement of the user devices.

By one approach the control circuit further serves to personalize the anonymized information to thereby provide data regarding movement of specifically-identified users. In this case that personalized movement information can be leveraged by the control circuit when facilitating the aforementioned allocation of unsold resources.

These teachings are highly flexible in practice and will accommodate various supplemental features and/or modifications. For example, the aforementioned allocation of unsold resources can comprise controlling inventory of goods at a retail shopping facility, controlling physical movement of goods (for example, to increase customer accessibility to the goods), and so forth. As another example, these teachings will accommodate configuring the control circuit to make the aforementioned allocation decisions regarding the unsold resources as a function, at least in part, of points of origin for the movement of the user devices and/or points of terminus for the movement of the user devices.

By one approach these teachings will further accommodate providing a memory having information stored therein that includes partiality information for each of a plurality of persons in the form of a plurality of partiality vectors for each of the persons wherein each partiality vector has at least one of a magnitude and an angle that corresponds to a magnitude of the person's belief in an amount of good that comes from an order associated with that partiality. This memory can also contain vectorized characterizations for each of a plurality of products, wherein each of the vectorized characterizations includes a measure regarding an extent to which a corresponding one of the products accords with a corresponding one of the plurality of partiality vectors. In such a case, the aforementioned control circuit can be further configured to access and utilize such information when making the aforementioned allocation decisions regarding unsold resources.

So configured, the allocation of physical real-world resources (i.e., non-digital content or applications) can be efficiently and accurately determined in ways that well serve the interests of both the consumer and those parties offering goods and services to such consumers.

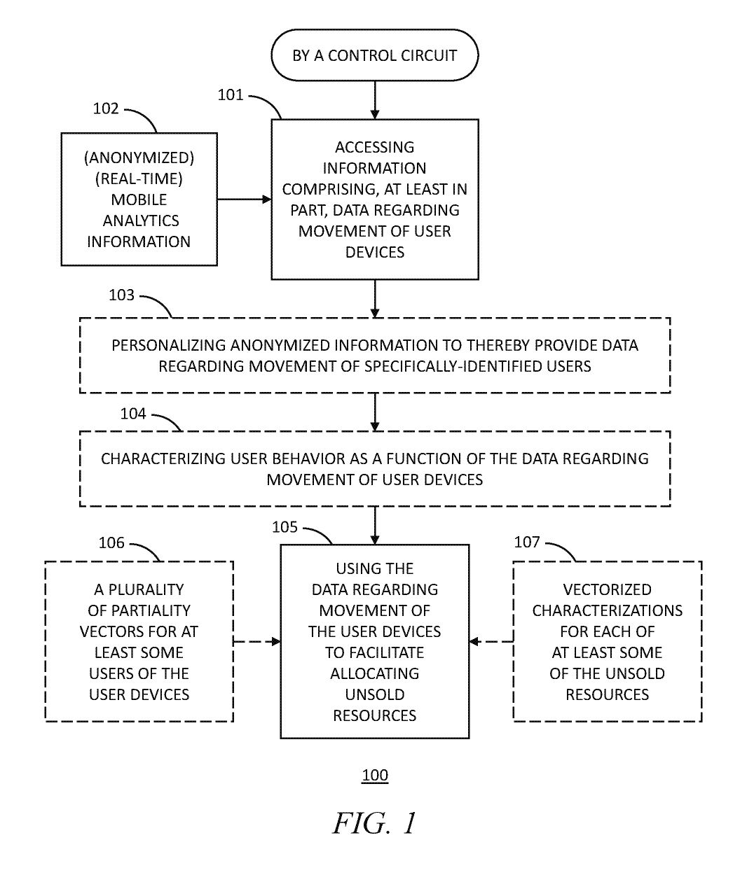

These and other benefits will become more evident upon making a thorough review and study of the following detailed description. Referring now to FIG. 1, these teachings will accommodate using a control circuit of choice to carry out the illustrative process 100. (Further description regarding such a control circuit appears further herein.) At block 101 this control circuit accesses mobile analytics information 102 that comprises data regarding movement of user devices. In a typical application setting this mobile analytics information 102 will constitute anonymized information that does not identify specific users. This information will also be presumed, for the purposes of this particular example, to comprise, at least in part, real-time data regarding movement of the user devices.

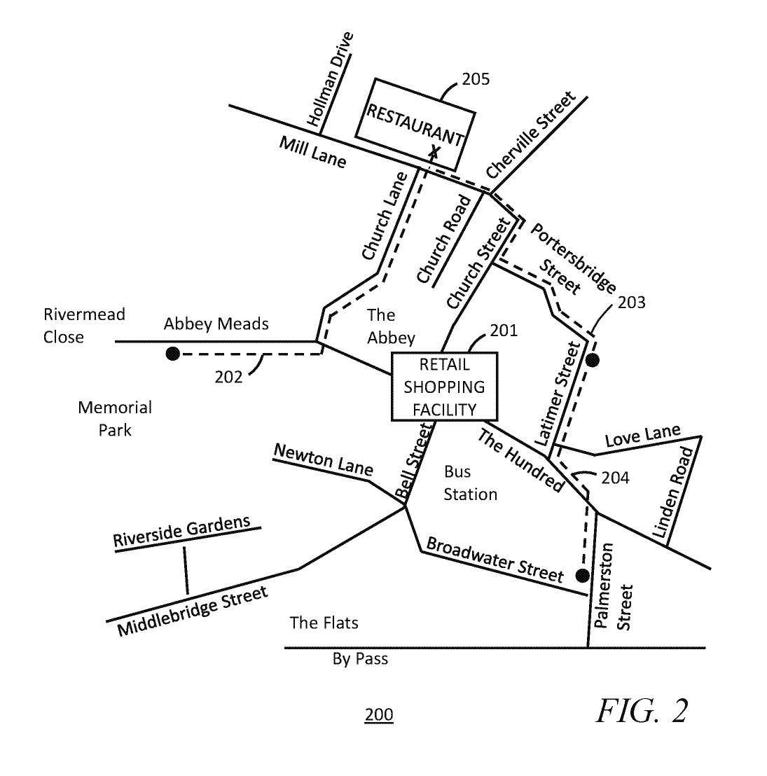

FIG. 2 provides a simple illustrative example in these regards. In particular, FIG. 2 presents an illustration of a street map for a region of interest 200. In this example a retail shopping facility 201 appears at the center of the region of interest 200.

As used herein, the expression “retail shopping facility” will be understood to refer to a facility that comprises a retail sales facility or any other type of bricks-and-mortar (i.e., physical) facility in which products are physically displayed and offered for sale to customers who physically visit the facility. The shopping facility may include one or more of sales floor areas, checkout locations (i.e., point of sale (POS) locations), customer service areas other than checkout locations (such as service areas to handle returns), parking locations, entrance and exit areas, stock room areas, stock receiving areas, hallway areas, common areas shared by merchants, and so on. The facility may be any size or format of facility, and may include products from one or more merchants. For example, a facility may be a single store operated by one merchant or may be a collection of stores covering multiple merchants such as a mall.

In this simple example the mobile analytics information 102 illustrates tracking information for three separate mobile devices (in this case, so-called smart phones). These three separate tracks are denoted by reference numerals 202-204. A dark circle denotes a point of origin and an “X” character denotes a terminus point, both as correspond to a particular journey for a particular mobile device. (It shall be understood that these conventions are used here for the sake of illustration and that any number of graphic approaches can be readily utilized to convey identical or similar information as desired.)

The mobile analytics information 102 can include, inferentially or explicitly, temporal information as well. In the illustration of FIG. 2, for example, the information displayed may represent a particular window of time such as 10 minutes, one hour, or one day (to note but a few possibilities in these regards). If desired, time information can be associated with one or more parts of an individually-displayed track (such as a start time associated with a point of origin or an arrival time associated with a terminus point).

The presentation of such information can be provided to a user on a real-time basis if desired or can be historical in nature if desired (for example, by displaying information from a previous day and without showing information that is more up to the minute). This mobile analytics information 102 can also be used by the control circuit without offering a corresponding display to a user if desired.

It will also be understood that color or other graphic affectations can be utilized as desired to impart information. For example, different colors can be utilized to disambiguate amongst a plurality of displayed devices. As another example, one color can serve to identify movement during one time of the day (such as during the morning hours) while another color identifies movement during a different time of the day (such as during the afternoon hours). And as yet another example, one color could indicate movement away from a region of interest while another, different color could indicate movement towards a region of interest.

The information presented in FIG. 2 includes only three devices/tracks. Only this limited number of devices are presented here for the sake of simplicity and clarity. In a typical application setting, dozens, hundreds, or even thousands of devices/tracks may be simultaneously available to the control circuit and/or presented on such a display/map. Accordingly, some mobile analytics platforms may provide the user with an opportunity to select and sort amongst a plurality of displayed devices/tracks to better facilitate the user's understanding and analysis of the displayed information.

This mobile analytics information 102 presumably provides no information that the control circuit can utilize to directly identify a user or other entity that corresponds to any of the tracked mobile devices. Notwithstanding the anonymous nature of the mobile analytics information, such mobile analytics information 102 can be used, if desired, to help inform and facilitate the allocation of unsold resources per these teachings.

That said, however, and as shown at optional block 103, these teachings also contemplate an approach that permits anonymous mobile analytics information to be personalized to thereby provide data regarding the movement of specifically-identified users. In a typical application setting this personalization is undertaken subject to the permission and possible other stipulations and requirements of the customer.

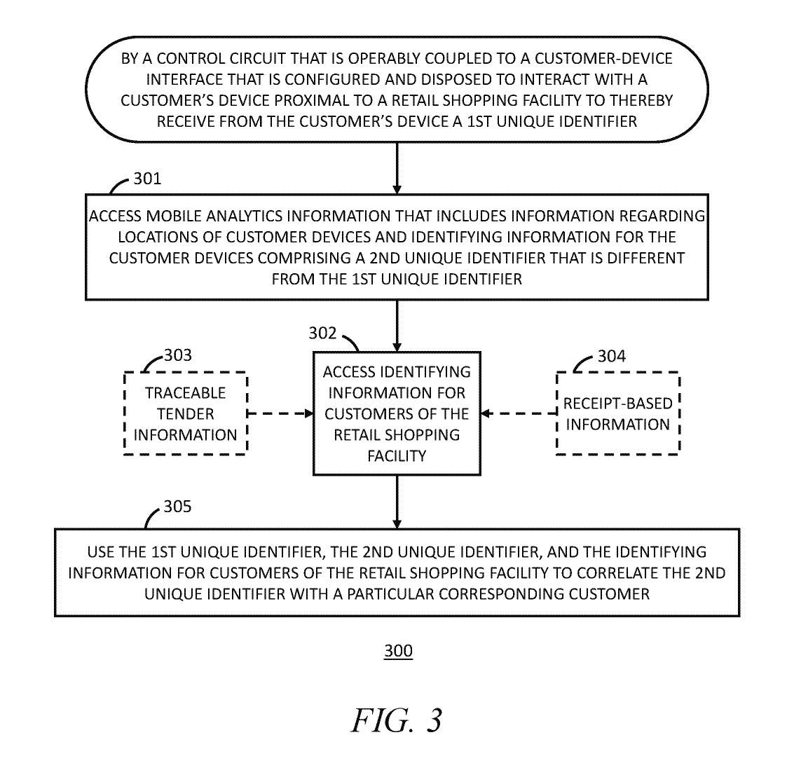

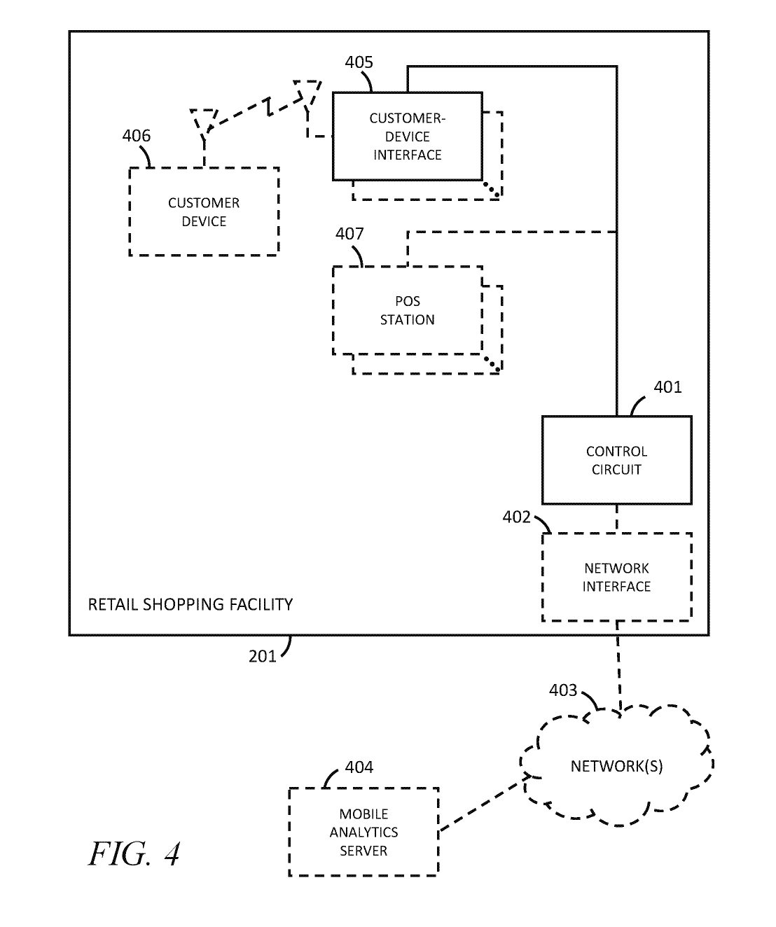

FIG. 3 presents a process 300 conducting such personalization of such data. In this example a control circuit that operably couples to a customer-device interface that interacts with a customer's device proximal to a retail shopping facility carries out this process 300 with FIG. 4 providing an illustrative example in this regard.

In this example a retail shopping facility 201 includes a control circuit 401. Being a “circuit,” this control circuit 401 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 401 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 401 is configured (for example, by using corresponding programming as will be well understood by those skilled in the art) to carry out one or more of the steps, actions, and/or functions described herein.

By one optional approach the control circuit 401 operably couples to a memory (not shown). This memory may be integral to the control circuit 401 or can be physically discrete (in whole or in part) from the control circuit 401 as desired. This memory can also be local with respect to the control circuit 401 (where, for example, both share a common circuit board, chassis, power supply, and/or housing) or can be partially or wholly remote with respect to the control circuit 401 (where, for example, the memory is physically located in another facility, metropolitan area, or even country as compared to the control circuit 401).

This memory can serve, for example, to non-transitorily store computer instructions that, when executed by the control circuit 401, cause the control circuit 401 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

By one approach the control circuit 401 optionally operably couples to a network interface 402. So configured the control circuit 401 can communicate with other network elements (such as but not limited to a mobile analytics server 404 that provides mobile analytics information per these teachings) using one or more intervening networks via the network interface 402. Network interfaces, including both wireless and non-wireless platforms, are well understood in the art and require no particular elaboration here. These teachings will support using any of a wide variety of networks including but not limited to the Internet (i.e., the global network of interconnected computer networks that use the Internet protocol suite (TCP/IP)).

In this illustrative example the control circuit 401 operably couples to at least one customer-device interface 405. The customer-device interface can comprise, by one approach, a wireless interface such as but not limited to a Wi-Fi access point and/or a Bluetooth transceiver. (As used herein “Wi-Fi” will be understood to refer to a technology that allows electronic devices to connect to a wireless Local Area Network (LAN) (generally using the 2.4 gigahertz and 5 gigahertz radio bands). More particularly, “Wi-Fi” refers to any Wireless Local Area Network (WLAN) product based on interoperability consistent with the Institute of Electrical and Electronics Engineers' (IEEE) 802.11 standards. Also as used herein, “Bluetooth” will be understood to refer to a wireless communications standard managed by the Bluetooth Special Interest Group. The Bluetooth standard makes use of frequency-hopping spread spectrum techniques and typically provides for only a very short range wireless connection (typically offering a range of only about ten meters in many common application settings). This standard comprises a packet-based approach that relies upon a so-called master-slave paradigm where a master device can support only a limited (plural) number of subservient devices.)

The customer-device interface 405 is configured and disposed to interact with a customer's device 406 proximal to the retail shopping facility 201. In a typical application setting this interaction will constitute a wireless communication of information. As used herein, the customer's device 406 is “proximal” to the retail shopping facility 201 when the customer's device 406 is within the retail shopping facility 201 and/or when the customer's device 406 is within a short distance of the retail shopping facility 201 (such as, for example, 1 meter, 5 meters, 10 meters, 30 meters, or some other minimal distance of choice).

As already noted above, the customer-device interface serves, at least in part, to receive from the customer's device 406 a first unique identifier. Generally speaking this first unique identifier does not directly identify the user of the customer's device 406. For example, the first unique identifier is not the full or abridged name of the customer nor a full or abridged name of a personally-selected customer avatar.

Instead, and by one approach, the first unique identifier comprises a Media Access Control (MAC) address for the customer's device 406. A MAC address of a computer is a unique identifier assigned to network interfaces for communications at the data link layer of a network segment. MAC addresses are used as a network address for many IEEE 802 network technologies, including Ethernet, Wi-Fi, and often Bluetooth. Logically, MAC addresses are used in the media access control protocol sublayer of the OSI reference model. MAC addresses are most often assigned by the manufacturer of a Network Interface Controller (NIC) and are stored in its hardware, such as the card's read-only memory or some other firmware mechanism. If assigned by the manufacturer, a MAC address usually encodes the manufacturer's registered identification number and may be referred to as the burned-in address. It may also be known as an Ethernet hardware address, hardware address, or physical address. MAC addresses are formed according to the rules of one of three numbering name spaces managed by the Institute of Electrical and Electronics Engineers, (i.e., MAC-48, EUI-48, and EUI-64).

As one illustrative example, the customer device 406 may comprise a so-called smart phone having Wi-Fi and/or Bluetooth conductivity capabilities. When the customer device 406 is within a range of the customer-device interface 405, these two elements may automatically communicate with one another during which communication the customer device 406 provides its MAC address to the customer-device interface 405. The customer-device interface 405 then supplies that MAC address to the control circuit 401.

As illustrated in FIG. 4, the retail shopping facility 201 may also optionally include one or more so-called point of sale (POS) stations 407. A POS station 407 is where a customer completes a retail transaction. Typically, the retailer calculates the amount owed by the customer and indicates that amount to the customer. The POS station 407 also serves as the point where the customer pays the retailer in exchange for goods or after provision of a service. After receiving payment, the retailer may issue a receipt (hard copy or otherwise) for the transaction. The POS station 407 may be directly attended by an associate of the retail shopping facility 201 or may be partially or wholly automated.

In many cases the customer's payment includes traceable tender information such as the customer's name or an identifier that can be readily and directly linked to the customer's name. In this example the control circuit 401 is configured to access at least some traceable tender information from a POS station 407 corresponding to purchases made by customers at the retail shopping facility 201.

With continued reference to FIGS. 3 and 4, this process 300 provides, at block 301, for having the control circuit 401 access mobile analytics information (sourced, for example, by the aforementioned mobile analytics server 404). This mobile analytics information includes information regarding locations of customer devices and identifying information for the customer devices comprising a second unique identifier that is different from the aforementioned first unique identifier.

The received information regarding locations of customer devices can vary as described above. By one approach the information provides mapped tracking information for a plurality of customer devices within some report region over some relevant period of time. Different colors can be used to parse the informational content and graphic icons can be utilized to indicate times, events, and other parameters of interest as desired.

Generally speaking, those who provide mobile analytics information do not provide that information in conjunction with any content that specifically identifies a particular user. For example, the provided content typically lacks user names or other user monikers, telephone numbers, email addresses, or the like. On the other hand, mobile analytics information often includes an identifier for each track and/or displayed device in order to help the analyst disambiguate the depicted information. The second unique identifier may therefore comprise, for example, a mobile device Electronic Serial Number (ESN), a mobile device International Mobile Equipment Identity (IMEI) number, or a (possibly random) number/identifier assigned by a wireless-communications service provider and/or the party providing the mobile analytics information.

It may be noted that the second unique identifier may be displayed on a map that presents the mobile analytics tracking data. By another approach the second unique identifier may be revealed by effecting some selection action with respect to a particular track (for example, double-clicking on a particular track). The present teachings are relatively insensitive to how the second unique identifiers are included with the received mobile analytics information.

At block 302 the control circuit 401 accesses identifying information for customers of the retail shopping facility 201. By one optional approach this identifying information may be obtained from traceable content information 303 that corresponds to purchases made by the customers at the retail shopping facility 201 as captured by, for example, the aforementioned POS station 407. For example, a customer's name is typically included with other information presented at the POS station 407 when paying for a purchase using a credit card or a debit card.

By another optional approach, in lieu of the foregoing or in combination therewith, the identifying information may be received along with other receipt-based information 304 that is provided directly by customers. Such receipt-based information 304 can also serve to correlate purchases made by customers at the retail shopping facility 201 with their corresponding identifying customer information. A customer can be enabled to directly provide such information using, for example, a smart phone app provided or otherwise supported by the enterprise that operates the retail sales facility 201. Such an app can provide an opportunity for the customer to maintain a virtual record of their shopping or can, for example, serve as a way for the customer to have the enterprise check and ensure that prices paid by the customer meet some pricing guarantee or policy of the enterprise.

At block 305, the control circuit 401 uses the first unique identifier, the second unique identifier, and the identifying information for customers of the retail shopping facility 201 to statistically (or, perhaps more accurately, by the process of elimination) correlate one of the second unique identifiers with a particular corresponding customer.

More specifically, for a given block of time the control circuit 401 knows which customer devices are likely at the retail shopping facility 201 by referencing the mobile analytics information. In particular, the control circuit 401 knows particular second unique identifiers that have arrived at the retail shopping facility 201. For that same block of time the control circuit 401 also knows which customer devices have presented the aforementioned first unique identifier at the retail shopping facility 201. And lastly, and again for that same block of time, the control circuit 401 further knows the names of (at least many) specific customers who made purchases at the retail shopping facility 201.

The control circuit 401 uses the foregoing information to accurately correlate a particular customer to a particular anonymized mobile device identifier as used with the mobile analytics information, in many cases, as a result of only a single customer visit to the retail shopping facility 201. In other cases there may be sufficient customer/device activity to create some ambiguity in these regards after only a single customer visit. In that case, the ambiguity can be relieved and an accurate correlation made after X number of additional visits by a particular customer to the retail shopping facility 201 (where X is an integer of 1 or greater).

So configured, and particularly over time, the control circuit 401 can personalize the previously anonymized mobile analytics information to thereby associate particular customers with particular identifiers for various mobile devices/tracks.

Referring again to FIG. 1, and specifically to optional block 104, these teachings will accommodate using the control circuit to characterize user behavior as a function of the data regarding movement of user devices. When the accessed data includes personalized mobile analytics information as described above, these characterizations can vary widely with the application setting and the individuals involved. Examples include but are not limited to which stores, entertainment venues, restaurants, schools, parks, gyms, and so forth are frequented by such persons and pursuant to what schedule or periodicity (if any).

As shown at block 105, the control circuit then uses the aforementioned data regarding movement of the user devices to facilitate allocating unsold resources per corresponding rules. When the unsold resources comprise goods, examples in these regards include controlling the inventory of the goods at a particular retail shopping facility and/or controlling physical movement (for example, via long distance or local transport) of the goods as a function of that data. Such control can be generally aimed at increasing customer accessibility to such goods (by, for example, transporting a quantity of such goods to a particular store by a particular time and/or by ensuring that backroom inventory is made available in the retail display area of the store by a particular time and/or at a particular customer-accessible location).

One way to facilitate the aforementioned allocation of unsold resources, at least in part, is by making those allocation decisions as a function of points of origin and/or points of terminus for the movement of the user devices. As one simple example in these regards, by knowing that many local residents (and hence a customer base geographically local to the retail shopping facility and hence likely to shop at the retail shopping facility) frequently visit a particular ethnic restaurant in another neighborhood (and hence bringing into play a corresponding rule that correlates a person's willingness to travel more than a given distance in order to experience a particular cuisine indicates a more-than-usual fondness for that cuisine), this process 100 will facilitate making a decision to allocate retail shelf space at the retail shopping facility to a greater-than-normal amount of cooking items (for example, spices or the like) that are characteristic of and typify the cuisine associated with that restaurant. Absent such data, it would otherwise be a matter of luck to identify such an inventory-stocking opportunity.

By one optional approach, and as illustrated in FIG. 1, when using the data regarding movement of user devices to facilitate allocating unsold resources the control circuit can also take into account information 106 comprising a plurality of partiality vectors for at least some users of the user devices along with information 107 comprising vectorized characterizations for each of at least some of the unsold resources. Some general and specific teachings regarding such vectors and vectorized characterizations will now be presented.

People tend to be partial to ordering various aspects of their lives, which is to say, people are partial to having things well arranged per their own personal view of how things should be. As a result, anything that contributes to the proper ordering of things regarding which a person has partialities represents value to that person. Quite literally, improving order reduces entropy for the corresponding person (i.e., a reduction in the measure of disorder present in that particular aspect of that person's life) and that improvement in order/reduction in disorder is typically viewed with favor by the affected person.

Generally speaking a value proposition must be coherent (logically sound) and have “force.” Here, force takes the form of an imperative. When the parties to the imperative have a reputation of being trustworthy and the value proposition is perceived to yield a good outcome, then the imperative becomes anchored in the center of a belief that “this is something that I must do because the results will be good for me.” With the imperative so anchored, the corresponding material space can be viewed as conforming to the order specified in the proposition that will result in the good outcome.

Newton's three laws of motion have a very strong bearing on the present teachings. Stated summarily, Newton's first law holds that an object either remains at rest or continues to move at a constant velocity unless acted upon by a net force, the second law holds that the vector sum of the forces F on an object equal the mass m of that object multiplied by the acceleration a of the object (i.e., F=ma), and the third law holds that when one body exerts a force on a second body, the second body simultaneously exerts a force equal in magnitude and opposite in direction on the first body.

Relevant to both the present teachings and Newton's first law, beliefs can be viewed as having inertia. In particular, once a person believes that a particular order is good, they tend to persist in maintaining that belief and resist moving away from that belief. The stronger that belief the more force an argument and/or fact will need to move that person away from that belief to a new belief.

Relevant to both the present teachings and Newton's second law, the “force” of a coherent argument can be viewed as equaling the “mass” which is the perceived Newtonian effort to impose the order that achieves the aforementioned belief in the good which an imposed order brings multiplied by the change in the belief of the good which comes from the imposition of that order. Consider that when a change in the value of a particular order is observed then there must have been a compelling value claim influencing that change. There is a proportionality in that the greater the change the stronger the value argument. If a person values a particular activity and is very diligent to do that activity even when facing great opposition, we say they are dedicated, passionate, and so forth. If they stop doing the activity, it begs the question, what made them stop? The answer to that question needs to carry enough force to account for the change.

And relevant to both the present teachings and Newton's third law, for every effort to impose good order there is an equal and opposite good reaction.

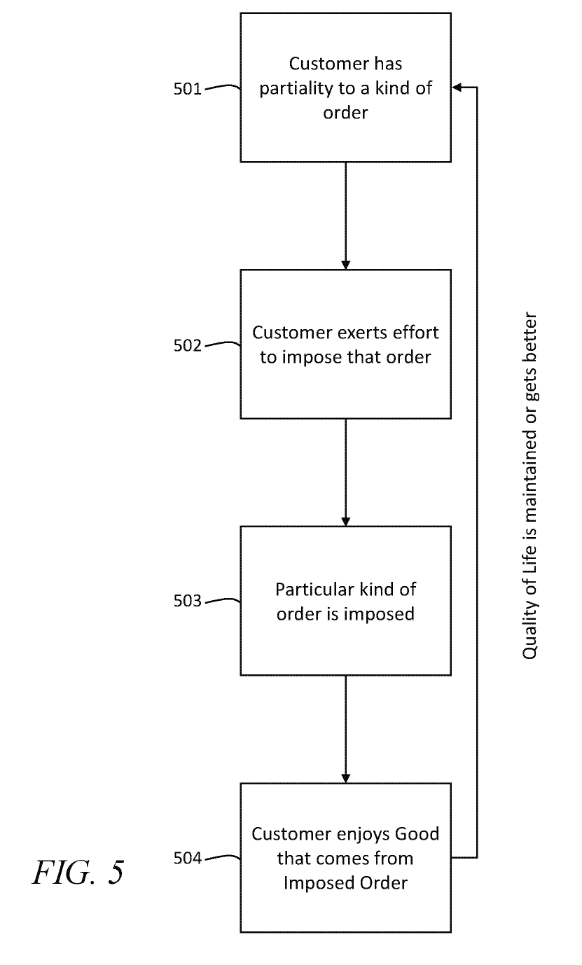

FIG. 5 provides a simple illustrative example in these regards. At block 501 it is understood that a particular person has a partiality (to a greater or lesser extent) to a particular kind of order. At block 502 that person willingly exerts effort to impose that order to thereby, at block 503, achieve an arrangement to which they are partial. And at block 504, this person appreciates the “good” that comes from successfully imposing the order to which they are partial, in effect establishing a positive feedback loop.

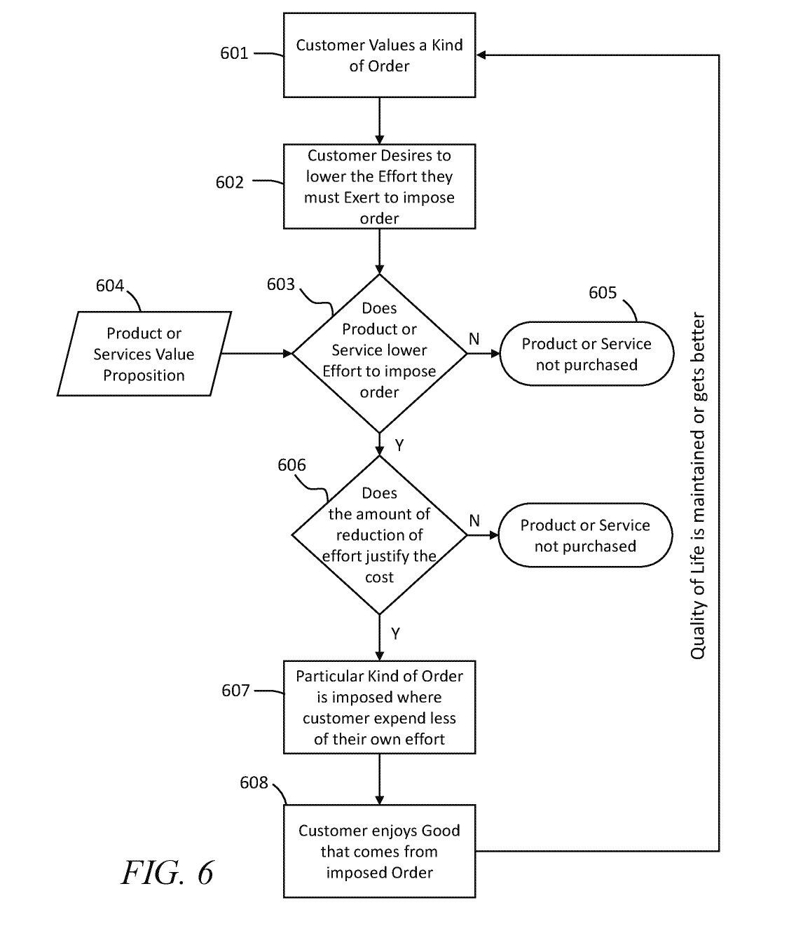

Understanding these partialities to particular kinds of order can be helpful to understanding how receptive a particular person may be to purchasing a given product or service. FIG. 6 provides a simple illustrative example in these regards. At block 601 it is understood that a particular person values a particular kind of order. At block 602 it is understood (or at least presumed) that this person wishes to lower the effort (or is at least receptive to lowering the effort) that they must personally exert to impose that order. At decision block 603 (and with access to information 604 regarding relevant products and or services) a determination can be made whether a particular product or service lowers the effort required by this person to impose the desired order. When such is not the case, it can be concluded that the person will not likely purchase such a product/service 605 (presuming better choices are available).

When the product or service does lower the effort required to impose the desired order, however, at block 606 a determination can be made as to whether the amount of the reduction of effort justifies the cost of purchasing and/or using the proffered product/service. If the cost does not justify the reduction of effort, it can again be concluded that the person will not likely purchase such a product/service 605. When the reduction of effort does justify the cost, however, this person may be presumed to want to purchase the product/service and thereby achieve the desired order (or at least an improvement with respect to that order) with less expenditure of their own personal effort (block 607) and thereby achieve, at block 608, corresponding enjoyment or appreciation of that result.

To facilitate such an analysis, the applicant has determined that factors pertaining to a person's partialities can be quantified and otherwise represented as corresponding vectors. These teachings will accommodate a variety of differing bases for such partialities including, for example, a person's values, affinities, aspirations, and preferences.

A value is a person's principle or standard of behavior, their judgment of what is important in life. A person's values represent their ethics, moral code, or morals and not a mere unprincipled liking or disliking of something. A person's value might be a belief in kind treatment of animals, a belief in cleanliness, a belief in the importance of personal care, and so forth.

An affinity is an attraction (or even a feeling of kinship) to a particular thing or activity. Examples including such a feeling towards a participatory sport such as golf or a spectator sport (including perhaps especially a particular team such as a particular professional or college football team), a hobby (such as quilting, model railroading, and so forth), one or more components of popular culture (such as a particular movie or television series, a genre of music or a particular musical performance group, or a given celebrity, for example), and so forth.

“Aspirations” refer to longer-range goals that require months or even years to reasonably achieve. As used herein “aspirations” does not include mere short term goals (such as making a particular meal tonight or driving to the store and back without a vehicular incident). The aspired-to goals, in turn, are goals pertaining to a marked elevation in one's core competencies (such as an aspiration to master a particular game such as chess, to achieve a particular articulated and recognized level of martial arts proficiency, or to attain a particular articulated and recognized level of cooking proficiency), professional status (such as an aspiration to receive a particular advanced education degree, to pass a professional examination such as a state Bar examination of a Certified Public Accountants examination, or to become Board certified in a particular area of medical practice), or life experience milestone (such as an aspiration to climb Mount Everest, to visit every state capital, or to attend a game at every major league baseball park in the United States). It will further be understood that the goal(s) of an aspiration is not something that can likely merely simply happen of its own accord; achieving an aspiration requires an intelligent effort to order one's life in a way that increases the likelihood of actually achieving the corresponding goal or goals to which that person aspires. One aspires to one day run their own business as versus, for example, merely hoping to one day win the state lottery.

A preference is a greater liking for one alternative over another or others. A person can prefer, for example, that their steak is cooked “medium” rather than other alternatives such as “rare” or “well done” or a person can prefer to play golf in the morning rather than in the afternoon or evening. Preferences can and do come into play when a given person makes purchasing decisions at a retail shopping facility. Preferences in these regards can take the form of a preference for a particular brand over other available brands or a preference for economy-sized packaging as versus, say, individual serving-sized packaging.

Values, affinities, aspirations, and preferences are not necessarily wholly unrelated. It is possible for a person's values, affinities, or aspirations to influence or even dictate their preferences in specific regards. For example, a person's moral code that values non-exploitive treatment of animals may lead them to prefer foods that include no animal-based ingredients and hence to prefer fruits and vegetables over beef and chicken offerings. As another example, a person's affinity for a particular musical group may lead them to prefer clothing that directly or indirectly references or otherwise represents their affinity for that group. As yet another example, a person's aspirations to become a Certified Public Accountant may lead them to prefer business-related media content.

While a value, affinity, or aspiration may give rise to or otherwise influence one or more corresponding preferences, however, is not to say that these things are all one and the same; they are not. For example, a preference may represent either a principled or an unprincipled liking for one thing over another, while a value is the principle itself. Accordingly, as used herein it will be understood that a partiality can include, in context, any one or more of a value-based, affinity-based, aspiration-based, and/or preference-based partiality.

Information regarding a given person's partialities can be acquired using any one or more of a variety of information-gathering and/or analytical approaches. By one simple approach, a person may voluntarily disclose information regarding their partialities (for example, in response to an online questionnaire or survey or as part of their social media presence). By another approach, the purchasing history for a given person can be analyzed to intuit the partialities that led to at least some of those purchases. By yet another approach demographic information regarding a particular person can serve as yet another source that sheds light on their partialities. Other ways that people reveal how they order their lives include but are not limited to: (1) their social networking profiles and behaviors (such as the things they “like” via Facebook, the images they post via Pinterest, informal and formal comments they initiate or otherwise provide in response to third-party postings including statements regarding their own personal long-term goals, the persons/topics they follow via Twitter, the photographs they publish via Picasso, and so forth); (2) their Internet surfing history; (3) their on-line or otherwise-published affinity-based memberships; (4) real-time (or delayed) information (such as steps walked, calories burned, geographic location, activities experienced, and so forth) from any of a variety of personal sensors (such as smart phones, tablet/pad-styled computers, fitness wearables, Global Positioning System devices, and so forth) and the so-called Internet of Things (such as smart refrigerators and pantries, entertainment and information platforms, exercise and sporting equipment, and so forth); (5) instructions, selections, and other inputs (including inputs that occur within augmented-reality user environments) made by a person via any of a variety of interactive interfaces (such as keyboards and cursor control devices, voice recognition, gesture-based controls, and eye tracking-based controls), and so forth.

The present teachings employ a vector-based approach to facilitate characterizing, representing, understanding, and leveraging such partialities to thereby identify products (and/or services) that will, for a particular corresponding consumer, provide for an improved or at least a favorable corresponding ordering for that consumer. Vectors are directed quantities that each have both a magnitude and a direction. Per the applicant's approach these vectors have a real, as versus a metaphorical, meaning in the sense of Newtonian physics. Generally speaking, each vector represents order imposed upon material space-time by a particular partiality.

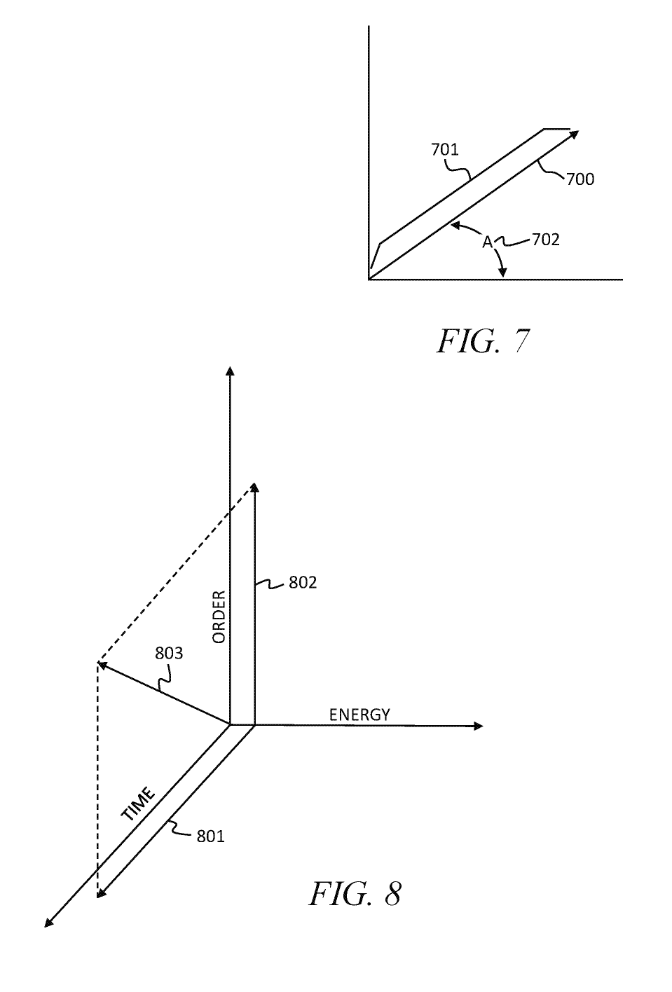

FIG. 7 provides some illustrative examples in these regards. By one approach the vector 700 has a corresponding magnitude 701 (i.e., length) that represents the magnitude of the strength of the belief in the good that comes from that imposed order (which belief, in turn, can be a function, relatively speaking, of the extent to which the order for this particular partiality is enabled and/or achieved). In this case, the greater the magnitude 701, the greater the strength of that belief and vice versa. Per another example, the vector 700 has a corresponding angle A 702 that instead represents the foregoing magnitude of the strength of the belief (and where, for example, an angle of 0° represents no such belief and an angle of 90° represents a highest magnitude in these regards, with other ranges being possible as desired).

Accordingly, a vector serving as a partiality vector can have at least one of a magnitude and an angle that corresponds to a magnitude of a particular person's belief in an amount of good that comes from an order associated with a particular partiality.

Applying force to displace an object with mass in the direction of a certain partiality-based order creates worth for a person who has that partiality. The resultant work (i.e., that force multiplied by the distance the object moves) can be viewed as a worth vector having a magnitude equal to the accomplished work and having a direction that represents the corresponding imposed order. If the resultant displacement results in more order of the kind that the person is partial to then the net result is a notion of “good.” This “good” is a real quantity that exists in meta-physical space much like work is a real quantity in material space. The link between the “good” in meta-physical space and the work in material space is that it takes work to impose order that has value.

In the context of a person, this effort can represent, quite literally, the effort that the person is willing to exert to be compliant with (or to otherwise serve) this particular partiality. For example, a person who values animal rights would have a large magnitude worth vector for this value if they exerted physical effort towards this cause by, for example, volunteering at animal shelters or by attending protests of animal cruelty.

While these teachings will readily employ a direct measurement of effort such as work done or time spent, these teachings will also accommodate using an indirect measurement of effort such as expense; in particular, money. In many cases people trade their direct labor for payment. The labor may be manual or intellectual. While salaries and payments can vary significantly from one person to another, a same sense of effort applies at least in a relative sense.

As a very specific example in these regards, there are wristwatches that require a skilled craftsman over a year to make. The actual aggregated amount of force applied to displace the small components that comprise the wristwatch would be relatively very small. That said, the skilled craftsman acquired the necessary skill to so assemble the wristwatch over many years of applying force to displace thousands of little parts when assembly previous wristwatches. That experience, based upon a much larger aggregation of previously-exerted effort, represents a genuine part of the “effort” to make this particular wristwatch and hence is fairly considered as part of the wristwatch's worth.

FIG. 8 presents a space graph that illustrates many of the foregoing points. A first vector 801 represents the time required to make such a wristwatch while a second vector 802 represents the order associated with such a device (in this case, that order essentially represents the skill of the craftsman). These two vectors 801 and 802 in turn sum to form a third vector 803 that constitutes a value vector for this wristwatch. This value vector 803, in turn, is offset with respect to energy (i.e., the energy associated with manufacturing the wristwatch).

A person partial to precision and/or to physically presenting an appearance of success and status (and who presumably has the wherewithal) may, in turn, be willing to spend $100,000 for such a wristwatch. A person able to afford such a price, of course, may themselves be skilled at imposing a certain kind of order that other persons are partial to such that the amount of physical work represented by each spent dollar is small relative to an amount of dollars they receive when exercising their skill(s). (Viewed another way, wearing an expensive wristwatch may lower the effort required for such a person to communicate that their own personal success comes from being highly skilled in a certain order of high worth.)

Generally speaking, all worth comes from imposing order on the material space-time. The worth of a particular order generally increases as the skill required to impose the order increases. Accordingly, unskilled labor may exchange $10 for every hour worked where the work has a high content of unskilled physical labor while a highly-skilled data scientist may exchange $75 for every hour worked with very little accompanying physical effort.

Consider a simple example where both of these laborers are partial to a well-ordered lawn and both have a corresponding partiality vector in those regards with a same magnitude. To observe that partiality the unskilled laborer may own an inexpensive push power lawn mower that this person utilizes for an hour to mow their lawn. The data scientist, on the other hand, pays someone else $75 in this example to mow their lawn. In both cases these two individuals traded one hour of worth creation to gain the same worth (to them) in the form of a well-ordered lawn; the unskilled laborer in the form of direct physical labor and the data scientist in the form of money that required one hour of their specialized effort to earn.

This same vector-based approach can also represent various products and services. This is because products and services have worth (or not) because they can remove effort (or fail to remove effort) out of the customer's life in the direction of the order to which the customer is partial. In particular, a product has a perceived effort embedded into each dollar of cost in the same way that the customer has an amount of perceived effort embedded into each dollar earned. A customer has an increased likelihood of responding to an exchange of value if the vectors for the product and the customer's partiality are directionally aligned and where the magnitude of the vector as represented in monetary cost is somewhat greater than the worth embedded in the customer's dollar.

Put simply, the magnitude (and/or angle) of a partiality vector for a person can represent, directly or indirectly, a corresponding effort the person is willing to exert to pursue that partiality. There are various ways by which that value can be determined. As but one non-limiting example in these regards, the magnitude/angle V of a particular partiality vector can be expressed as:

$$V = [ \begin{matrix}{X}_{1} \\ ⋮ \\ {X}_{n}\end{matrix} ] [ {W}_{1} … {W}_{n} ]$$

where X refers to any of a variety of inputs (such as those described above) that can impact the characterization of a particular partiality (and where these teachings will accommodate either or both subjective and objective inputs as desired) and W refers to weighting factors that are appropriately applied the foregoing input values (and where, for example, these weighting factors can have values that themselves reflect a particular person's consumer personality or otherwise as desired and can be static or dynamically valued in practice as desired).

In the context of a product (or service) the magnitude/angle of the corresponding vector can represent the reduction of effort that must be exerted when making use of this product to pursue that partiality, the effort that was expended in order to create the product/service, the effort that the person perceives can be personally saved while nevertheless promoting the desired order, and/or some other corresponding effort. Taken as a whole the sum of all the vectors must be perceived to increase the overall order to be considered a good product/service.

By forming reliable partiality vectors for various individuals and corresponding product characterization vectors for a variety of products and/or services, these teachings provide a useful and reliable way to identify products/services that accord with a given person's own partialities (whether those partialities are based on their values, their affinities, their preferences, or otherwise).

It is of course possible that partiality vectors may not be available yet for a given person due to a lack of sufficient specific source information from or regarding that person. In this case it may nevertheless be possible to use one or more partiality vector templates that generally represent certain groups of people that fairly include this particular person. For example, if the person's gender, age, academic status/achievements, and/or postal code are known it may be useful to utilize a template that includes one or more partiality vectors that represent some statistical average or norm of other persons matching those same characterizing parameters. (Of course, while it may be useful to at least begin to employ these teachings with certain individuals by using one or more such templates, these teachings will also accommodate modifying (perhaps significantly and perhaps quickly) such a starting point over time as part of developing a more personal set of partiality vectors that are specific to the individual.) A variety of templates could be developed based, for example, on professions, academic pursuits and achievements, nationalities and/or ethnicities, characterizing hobbies, and the like.

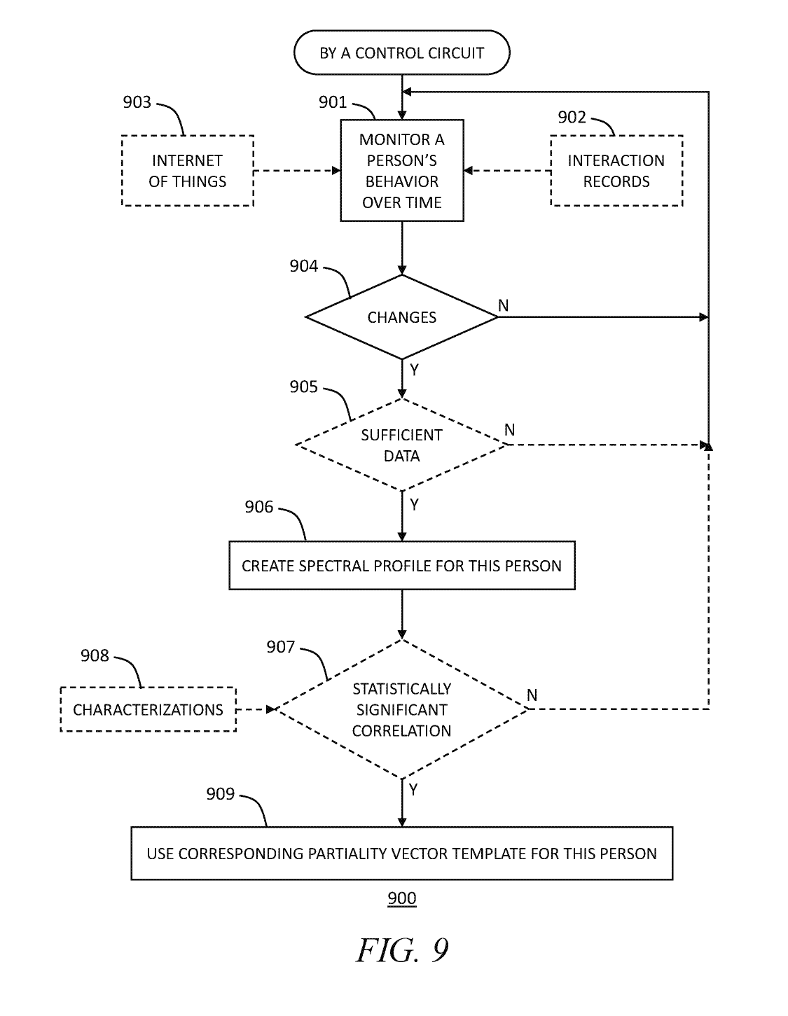

FIG. 9 presents a process 900 that illustrates yet another approach in these regards. For the sake of an illustrative example it will be presumed here that a control circuit of choice (with useful examples in these regards being presented further below) carries out one or more of the described steps/actions.

At block 901 the control circuit monitors a person's behavior over time. The range of monitored behaviors can vary with the individual and the application setting. By one approach, only behaviors that the person has specifically approved for monitoring are so monitored.

As one example in these regards, this monitoring can be based, in whole or in part, upon interaction records 902 that reflect or otherwise track, for example, the monitored person's purchases. This can include specific items purchased by the person, from whom the items were purchased, where the items were purchased, how the items were purchased (for example, at a bricks-and-mortar physical retail shopping facility or via an on-line shopping opportunity), the price paid for the items, and/or which items were returned and when), and so forth.

As another example in these regards the interaction records 902 can pertain to the social networking behaviors of the monitored person including such things as their “likes,” their posted comments, images, and tweets, affinity group affiliations, their on-line profiles, their playlists and other indicated “favorites,” and so forth. Such information can sometimes comprise a direct indication of a particular partiality or, in other cases, can indirectly point towards a particular partiality and/or indicate a relative strength of the person's partiality.

Other interaction records of potential interest include but are not limited to registered political affiliations and activities, credit reports, military-service history, educational and employment history, and so forth.

As another example, in lieu of the foregoing or in combination therewith, this monitoring can be based, in whole or in part, upon sensor inputs from the Internet of Things (TOT) 903. The Internet of Things refers to the Internet-based inter-working of a wide variety of physical devices including but not limited to wearable or carriable devices, vehicles, buildings, and other items that are embedded with electronics, software, sensors, network connectivity, and sometimes actuators that enable these objects to collect and exchange data via the Internet. In particular, the Internet of Things allows people and objects pertaining to people to be sensed and corresponding information to be transferred to remote locations via intervening network infrastructure. Some experts estimate that the Internet of Things will consist of almost 50 billion such objects by 2020.

Depending upon what sensors a person encounters, information can be available regarding a person's travels, lifestyle, calorie expenditure over time, diet, habits, interests and affinities, choices and assumed risks, and so forth. This process 900 will accommodate either or both real-time or non-real time access to such information as well as either or both push and pull-based paradigms.

By monitoring a person's behavior over time a general sense of that person's daily routine can be established (sometimes referred to herein as a routine experiential base state). As a very simple illustrative example, a routine experiential base state can include a typical daily event timeline for the person that represents typical locations that the person visits and/or typical activities in which the person engages. The timeline can indicate those activities that tend to be scheduled (such as the person's time at their place of employment or their time spent at their child's sports practices) as well as visits/activities that are normal for the person though not necessarily undertaken with strict observance to a corresponding schedule (such as visits to local stores, movie theaters, and the homes of nearby friends and relatives).

At block 904 this process 900 provides for detecting changes to that established routine. These teachings are highly flexible in these regards and will accommodate a wide variety of “changes.” Some illustrative examples include but are not limited to changes with respect to a person's travel schedule, destinations visited or time spent at a particular destination, the purchase and/or use of new and/or different products or services, a subscription to a new magazine, a new Rich Site Summary (RSS) feed or a subscription to a new blog, a new “friend” or “connection” on a social networking site, a new person, entity, or cause to follow on a Twitter-like social networking service, enrollment in an academic program, and so forth.

Upon detecting a change, at optional block 905 this process 900 will accommodate assessing whether the detected change constitutes a sufficient amount of data to warrant proceeding further with the process. This assessment can comprise, for example, assessing whether a sufficient number (i.e., a predetermined number) of instances of this particular detected change have occurred over some predetermined period of time. As another example, this assessment can comprise assessing whether the specific details of the detected change are sufficient in quantity and/or quality to warrant further processing. For example, merely detecting that the person has not arrived at their usual 6 PM-Wednesday dance class may not be enough information, in and of itself, to warrant further processing, in which case the information regarding the detected change may be discarded or, in the alternative, cached for further consideration and use in conjunction or aggregation with other, later-detected changes.

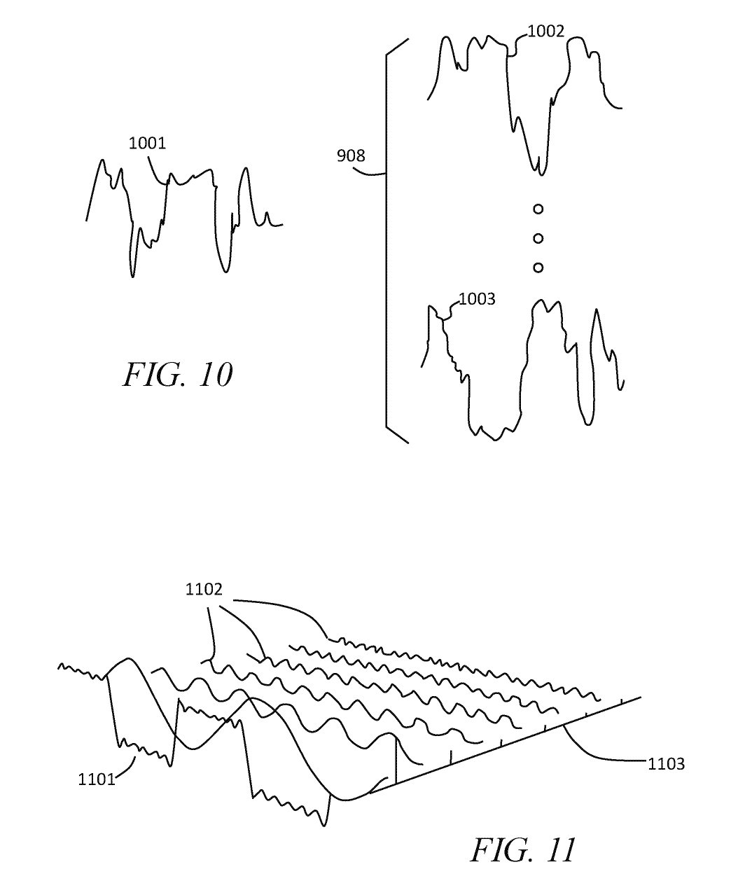

At block 907 this process 900 uses these detected changes to create a spectral profile for the monitored person. FIG. 10 provides an illustrative example in these regards with the spectral profile denoted by reference numeral 1001. In this illustrative example the spectral profile 1001 represents changes to the person's behavior over a given period of time (such as an hour, a day, a week, or some other temporal window of choice). Such a spectral profile can be as multidimensional as may suit the needs of a given application setting.

At optional block 907 this process 900 then provides for determining whether there is a statistically significant correlation between the aforementioned spectral profile and any of a plurality of like characterizations 908. The like characterizations 908 can comprise, for example, spectral profiles that represent an average of groupings of people who share many of the same (or all of the same) identified partialities. As a very simple illustrative example in these regards, a first such characterization 1002 might represent a composite view of a first group of people who have three similar partialities but a dissimilar fourth partiality while another of the characterizations 1003 might represent a composite view of a different group of people who share all four partialities.

The aforementioned “statistically significant” standard can be selected and/or adjusted to suit the needs of a given application setting. The scale or units by which this measurement can be assessed can be any known, relevant scale/unit including, but not limited to, scales such as standard deviations, cumulative percentages, percentile equivalents, Z-scores, T-scores, standard nines, and percentages in standard nines. Similarly, the threshold by which the level of statistical significance is measured/assessed can be set and selected as desired. By one approach the threshold is static such that the same threshold is employed regardless of the circumstances. By another approach the threshold is dynamic and can vary with such things as the relative size of the population of people upon which each of the characterizations 508 are based and/or the amount of data and/or the duration of time over which data is available for the monitored person.

Referring now to FIG. 11, by one approach the selected characterization (denoted by reference numeral 1101 in this figure) comprises an activity profile over time of one or more human behaviors. Examples of behaviors include but are not limited to such things as repeated purchases over time of particular commodities, repeated visits over time to particular locales such as certain restaurants, retail outlets, athletic or entertainment facilities, and so forth, and repeated activities over time such as floor cleaning, dish washing, car cleaning, cooking, volunteering, and so forth. Those skilled in the art will understand and appreciate, however, that the selected characterization is not, in and of itself, demographic data (as described elsewhere herein).

More particularly, the characterization 1101 can represent (in this example, for a plurality of different behaviors) each instance over the monitored/sampled period of time when the monitored/represented person engages in a particular represented behavior (such as visiting a neighborhood gym, purchasing a particular product (such as a consumable perishable or a cleaning product), interacts with a particular affinity group via social networking, and so forth). The relevant overall time frame can be chosen as desired and can range in a typical application setting from a few hours or one day to many days, weeks, or even months or years. (It will be understood by those skilled in the art that the particular characterization shown in FIG. 11 is intended to serve an illustrative purpose and does not necessarily represent or mimic any particular behavior or set of behaviors).

Generally speaking it is anticipated that many behaviors of interest will occur at regular or somewhat regular intervals and hence will have a corresponding frequency or periodicity of occurrence. For some behaviors that frequency of occurrence may be relatively often (for example, oral hygiene events that occur at least once, and often multiple times each day) while other behaviors (such as the preparation of a holiday meal) may occur much less frequently (such as only once, or only a few times, each year). For at least some behaviors of interest that general (or specific) frequency of occurrence can serve as a significant indication of a person's corresponding partialities.

By one approach, these teachings will accommodate detecting and timestamping each and every event/activity/behavior or interest as it happens. Such an approach can be memory intensive and require considerable supporting infrastructure.

The present teachings will also accommodate, however, using any of a variety of sampling periods in these regards. In some cases, for example, the sampling period per se may be one week in duration. In that case, it may be sufficient to know that the monitored person engaged in a particular activity (such as cleaning their car) a certain number of times during that week without known precisely when, during that week, the activity occurred. In other cases it may be appropriate or even desirable, to provide greater granularity in these regards. For example, it may be better to know which days the person engaged in the particular activity or even the particular hour of the day. Depending upon the selected granularity/resolution, selecting an appropriate sampling window can help reduce data storage requirements (and/or corresponding analysis/processing overhead requirements).

Although a given person's behaviors may not, strictly speaking, be continuous waves (as shown in FIG. 11) in the same sense as, for example, a radio or acoustic wave, it will nevertheless be understood that such a behavioral characterization 1101 can itself be broken down into a plurality of sub-waves 1102 that, when summed together, equal or at least approximate to some satisfactory degree the behavioral characterization 1101 itself. (The more-discrete and sometimes less-rigidly periodic nature of the monitored behaviors may introduce a certain amount of error into the corresponding sub-waves. There are various mathematically satisfactory ways by which such error can be accommodated including by use of weighting factors and/or expressed tolerances that correspond to the resultant sub-waves.)

It should also be understood that each such sub-wave can often itself be associated with one or more corresponding discrete partialities. For example, a partiality reflecting concern for the environment may, in turn, influence many of the included behavioral events (whether they are similar or dissimilar behaviors or not) and accordingly may, as a sub-wave, comprise a relatively significant contributing factor to the overall set of behaviors as monitored over time. These sub-waves (partialities) can in turn be clearly revealed and presented by employing a transform (such as a Fourier transform) of choice to yield a spectral profile 1103 wherein the X axis represents frequency and the Y axis represents the magnitude of the response of the monitored person at each frequency/sub-wave of interest.

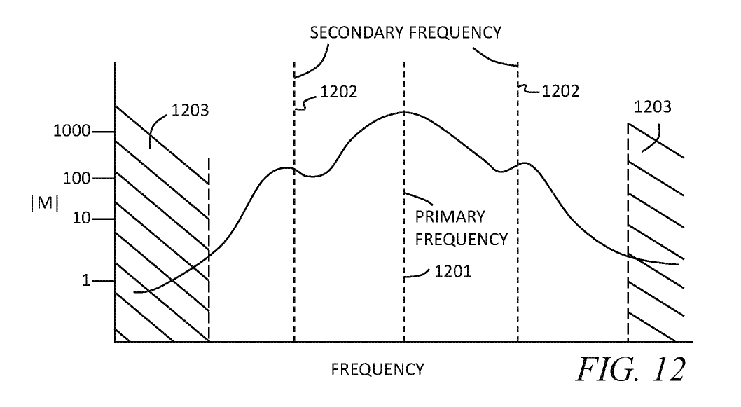

This spectral response of a given individual—which is generated from a time series of events that reflect/track that person's behavior—yields frequency response characteristics for that person that are analogous to the frequency response characteristics of physical systems such as, for example, an analog or digital filter or a second order electrical or mechanical system. Referring to FIG. 12, for many people the spectral profile of the individual person will exhibit a primary frequency 1201 for which the greatest response (perhaps many orders of magnitude greater than other evident frequencies) to life is exhibited and apparent. In addition, the spectral profile may also possibly identify one or more secondary frequencies 1202 above and/or below that primary frequency 1201. (It may be useful in many application settings to filter out more distant frequencies 1203 having considerably lower magnitudes because of a reduced likelihood of relevance and/or because of a possibility of error in those regards; in effect, these lower-magnitude signals constitute noise that such filtering can remove from consideration.)

As noted above, the present teachings will accommodate using sampling windows of varying size. By one approach the frequency of events that correspond to a particular partiality can serve as a basis for selecting a particular sampling rate to use when monitoring for such events. For example, Nyquist-based sampling rules (which dictate sampling at a rate at least twice that of the frequency of the signal of interest) can lead one to choose a particular sampling rate (and the resultant corresponding sampling window size).

As a simple illustration, if the activity of interest occurs only once a week, then using a sampling of half-a-week and sampling twice during the course of a given week will adequately capture the monitored event. If the monitored person's behavior should change, a corresponding change can be automatically made. For example, if the person in the foregoing example begins to engage in the specified activity three times a week, the sampling rate can be switched to six times per week (in conjunction with a sampling window that is resized accordingly).

By one approach, the sampling rate can be selected and used on a partiality-by-partiality basis. This approach can be especially useful when different monitoring modalities are employed to monitor events that correspond to different partialities. If desired, however, a single sampling rate can be employed and used for a plurality (or even all) partialities/behaviors. In that case, it can be useful to identify the behavior that is exemplified most often (i.e., that behavior which has the highest frequency) and then select a sampling rate that is at least twice that rate of behavioral realization, as that sampling rate will serve well and suffice for both that highest-frequency behavior and all lower-frequency behaviors as well.

It can be useful in many application settings to assume that the foregoing spectral profile of a given person is an inherent and immutable characteristic of that person and that this spectral profile, in essence, provides a personality profile of that person that reflects not only how but why this person responds to a variety of life experiences. More importantly, the partialities expressed by the spectral profile for a given person will tend to persist going forward and will not typically change significantly in the absence of some powerful external influence (including but not limited to significant life events such as, for example, marriage, children, loss of job, promotion, and so forth).

In any event, by knowing a priori the particular partialities (and corresponding strengths) that underlie the particular characterization 1101, those partialities can be used as an initial template for a person whose own behaviors permit the selection of that particular characterization 1101. In particular, those particularities can be used, at least initially, for a person for whom an amount of data is not otherwise available to construct a similarly rich set of partiality information.

As a very specific and non-limiting example, per these teachings the choice to make a particular product can include consideration of one or more value systems of potential customers. When considering persons who value animal rights, a product conceived to cater to that value proposition may require a corresponding exertion of additional effort to order material space-time such that the product is made in a way that (A) does not harm animals and/or (even better) (B) improves life for animals (for example, eggs obtained from free range chickens). The reason a person exerts effort to order material space-time is because they believe it is good to do and/or not good to not do so. When a person exerts effort to do good (per their personal standard of “good”) and if that person believes that a particular order in material space-time (that includes the purchase of a particular product) is good to achieve, then that person will also believe that it is good to buy as much of that particular product (in order to achieve that good order) as their finances and needs reasonably permit (all other things being equal).

The aforementioned additional effort to provide such a product can (typically) convert to a premium that adds to the price of that product. A customer who puts out extra effort in their life to value animal rights will typically be willing to pay that extra premium to cover that additional effort exerted by the company. By one approach a magnitude that corresponds to the additional effort exerted by the company can be added to the person's corresponding value vector because a product or service has worth to the extent that the product/service allows a person to order material space-time in accordance with their own personal value system while allowing that person to exert less of their own effort in direct support of that value.

By one approach there can be hundreds or even thousands of identified partialities. In this case, if desired, each product/service of interest can be assessed with respect to each and every one of these partialities and a corresponding partiality vector formed to thereby build a collection of partiality vectors that collectively characterize the product/service. As a very simple example in these regards, a given laundry detergent might have a cleanliness partiality vector with a relatively high magnitude (representing the effectiveness of the detergent), a ecology partiality vector that might be relatively low or possibly even having a negative magnitude (representing an ecologically disadvantageous effect of the detergent post usage), and a simple-life partiality vector with only a modest magnitude (representing the relative ease of use of the detergent but also that the detergent presupposes that the user has a modern washing machine). Other partiality vectors for this detergent, representing such things as nutrition or mental acuity, might have magnitudes of zero.

As mentioned above, these teachings can accommodate partiality vectors having a negative magnitude. Consider, for example, a partiality vector representing a desire to order things to reduce one's so-called carbon footprint. A magnitude of zero for this vector would indicate a completely neutral effect with respect to carbon emissions while any positive-valued magnitudes would represent a net reduction in the amount of carbon in the atmosphere. Negative magnitudes would represent the introduction of carbon emissions (for example, as a result of manufacturing the product, transporting the product, and/or using the product)

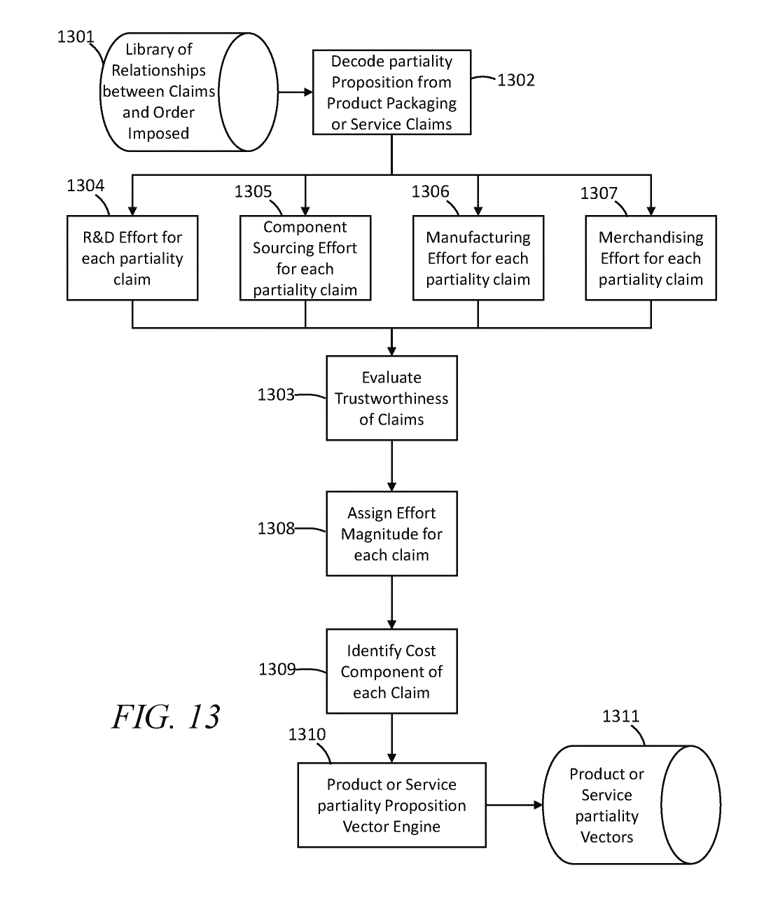

FIG. 13 presents one non-limiting illustrative example in these regards. The illustrated process presumes the availability of a library 1301 of correlated relationships between product/service claims and particular imposed orders. Examples of product/service claims include such things as claims that a particular product results in cleaner laundry or household surfaces, or that a particular product is made in a particular political region (such as a particular state or country), or that a particular product is better for the environment, and so forth. The imposed orders to which such claims are correlated can reflect orders as described above that pertain to corresponding partialities.

At block 1302 this process provides for decoding one or more partiality propositions from specific product packaging (or service claims). For example, the particular textual/graphics-based claims presented on the packaging of a given product can be used to access the aforementioned library 1301 to identify one or more corresponding imposed orders from which one or more corresponding partialities can then be identified.

At block 1303 this process provides for evaluating the trustworthiness of the aforementioned claims. This evaluation can be based upon any one or more of a variety of data points as desired. FIG. 13 illustrates four significant possibilities in these regards. For example, at block 1304 an actual or estimated research and development effort can be quantified for each claim pertaining to a partiality. At block 1305 an actual or estimated component sourcing effort for the product in question can be quantified for each claim pertaining to a partiality. At block 1306 an actual or estimated manufacturing effort for the product in question can be quantified for each claim pertaining to a partiality. And at block 1307 an actual or estimated merchandising effort for the product in question can be quantified for each claim pertaining to a partiality.

If desired, a product claim lacking sufficient trustworthiness may simply be excluded from further consideration. By another approach the product claim can remain in play but a lack of trustworthiness can be reflected, for example, in a corresponding partiality vector direction or magnitude for this particular product.

At block 1308 this process provides for assigning an effort magnitude for each evaluated product/service claim. That effort can constitute a one-dimensional effort (reflecting, for example, only the manufacturing effort) or can constitute a multidimensional effort that reflects, for example, various categories of effort such as the aforementioned research and development effort, component sourcing effort, manufacturing effort, and so forth.

At block 1309 this process provides for identifying a cost component of each claim, this cost component representing a monetary value. At block 1310 this process can use the foregoing information with a product/service partiality propositions vector engine to generate a library 1311 of one or more corresponding partiality vectors for the processed products/services. Such a library can then be used as described herein in conjunction with partiality vector information for various persons to identify, for example, products/services that are well aligned with the partialities of specific individuals.

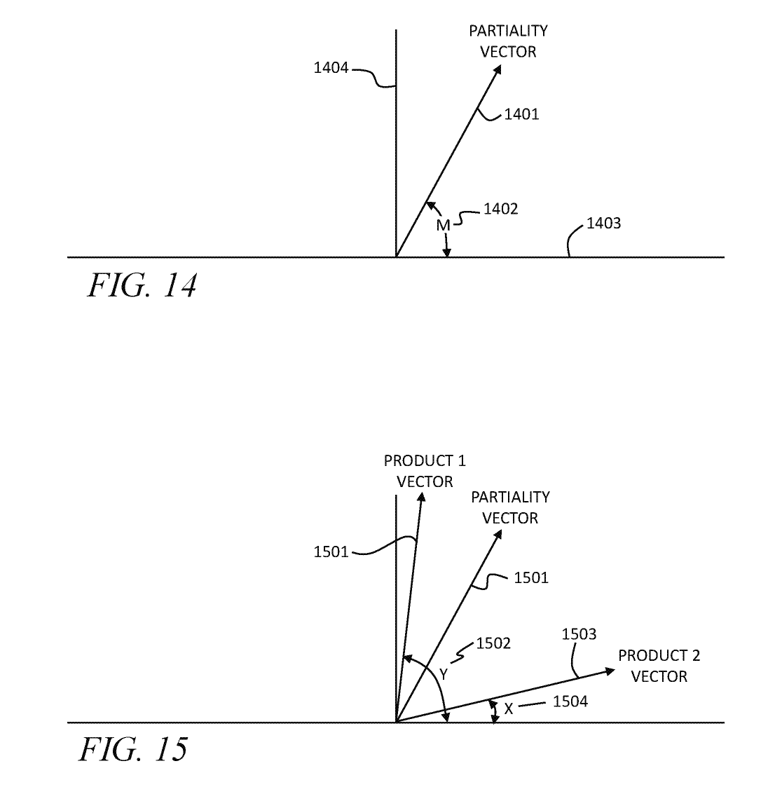

As noted above, the magnitude corresponding to a particular partiality vector for a particular person can be expressed by the angle of that partiality vector. FIG. 14 provides an illustrative example in these regards. In this example the partiality vector 1401 has an angle M 1402 (and where the range of available positive magnitudes range from a minimal magnitude represented by 0° (as denoted by reference numeral 1403) to a maximum magnitude represented by 90° (as denoted by reference numeral 1404)). Accordingly, the person to whom this partiality vector 1401 pertains has a relatively strong (but not absolute) belief in an amount of good that comes from an order associated with that partiality.

FIG. 15, in turn, presents that partiality vector 1501 in context with the product characterization vectors 1501 and 1503 for a first product and a second product, respectively. In this example the product characterization vector 1501 for the first product has an angle Y 1502 that is greater than the angle M 1402 for the aforementioned partiality vector 1401 by a relatively small amount while the product characterization vector 1503 for the second product has an angle X 1504 that is considerably smaller than the angle M 1402 for the partiality vector 1401.

Since, in this example, the angles of the various vectors represent the magnitude of the person's specified partiality or the extent to which the product aligns with that partiality, respectively, vector dot product calculations can serve to help identify which product best aligns with this partiality. Such an approach can be particularly useful when the lengths of the vectors are allowed to vary as a function of one or more parameters of interest. As those skilled in the art will understand, a vector dot product is an algebraic operation that takes two equal-length sequences of numbers (in this case, coordinate vectors) and returns a single number.

This operation can be defined either algebraically or geometrically. Algebraically, it is the sum of the products of the corresponding entries of the two sequences of numbers. Geometrically, it is the product of the Euclidean magnitudes of the two vectors and the cosine of the angle between them. The result is a scalar rather than a vector. As regards the present illustrative example, the resultant scaler value for the vector dot product of the product 1 vector 1501 with the partiality vector 1401 will be larger than the resultant scaler value for the vector dot product of the product 2 vector 1503 with the partiality vector 1401. Accordingly, when using vector angles to impart this magnitude information, the vector dot product operation provides a simple and convenient way to determine proximity between a particular partiality and the performance/properties of a particular product to thereby greatly facilitate identifying a best product amongst a plurality of candidate products.

By way of further illustration, consider an example where a particular consumer as a strong partiality for organic produce and is financially able to afford to pay to observe that partiality. A dot product result for that person with respect to a product characterization vector(s) for organic apples that represent a cost of $10 on a weekly basis (i.e., Cv·P1v) might equal (1,1), hence yielding a scalar result of ∥1∥ (where Cv refers to the corresponding partiality vector for this person and P1v represents the corresponding product characterization vector for these organic apples). Conversely, a dot product result for this same person with respect to a product characterization vector(s) for non-organic apples that represent a cost of $5 on a weekly basis (i.e., Cv·P2v) might instead equal (1,0), hence yielding a scalar result of ∥½∥. Accordingly, although the non-organic apples cost more than the organic apples, the dot product result for the organic apples exceeds the dot product result for the non-organic apples and therefore identifies the more expensive organic apples as being the best choice for this person.

To continue with the foregoing example, consider now what happens when this person subsequently experiences some financial misfortune (for example, they lose their job and have not yet found substitute employment). Such an event can present the “force” necessary to alter the previously-established “inertia” of this person's steady-state partialities; in particular, these negatively-changed financial circumstances (in this example) alter this person's budget sensitivities (though not, of course their partiality for organic produce as compared to non-organic produce). The scalar result of the dot product for the $5/week non-organic apples may remain the same (i.e., in this example, ∥½∥), but the dot product for the $10/week organic apples may now drop (for example, to ∥½∥ as well). Dropping the quantity of organic apples purchased, however, to reflect the tightened financial circumstances for this person may yield a better dot product result. For example, purchasing only $5 (per week) of organic apples may produce a dot product result of IN. The best result for this person, then, under these circumstances, is a lesser quantity of organic apples rather than a larger quantity of non-organic apples.

In a typical application setting, it is possible that this person's loss of employment is not, in fact, known to the system. Instead, however, this person's change of behavior (i.e., reducing the quantity of the organic apples that are purchased each week) might well be tracked and processed to adjust one or more partialities (either through an addition or deletion of one or more partialities and/or by adjusting the corresponding partiality magnitude) to thereby yield this new result as a preferred result.

The foregoing simple examples clearly illustrate that vector dot product approaches can be a simple yet powerful way to quickly eliminate some product options while simultaneously quickly highlighting one or more product options as being especially suitable for a given person.

Such vector dot product calculations and results, in turn, help illustrate another point as well. As noted above, sine waves can serve as a potentially useful way to characterize and view partiality information for both people and products/services. In those regards, it is worth noting that a vector dot product result can be a positive, zero, or even negative value. That, in turn, suggests representing a particular solution as a normalization of the dot product value relative to the maximum possible value of the dot product. Approached this way, the maximum amplitude of a particular sine wave will typically represent a best solution.

Taking this approach further, by one approach the frequency (or, if desired, phase) of the sine wave solution can provide an indication of the sensitivity of the person to product choices (for example, a higher frequency can indicate a relatively highly reactive sensitivity while a lower frequency can indicate the opposite). A highly sensitive person is likely to be less receptive to solutions that are less than fully optimum and hence can help to narrow the field of candidate products while, conversely, a less sensitive person is likely to be more receptive to solutions that are less than fully optimum and can help to expand the field of candidate products.

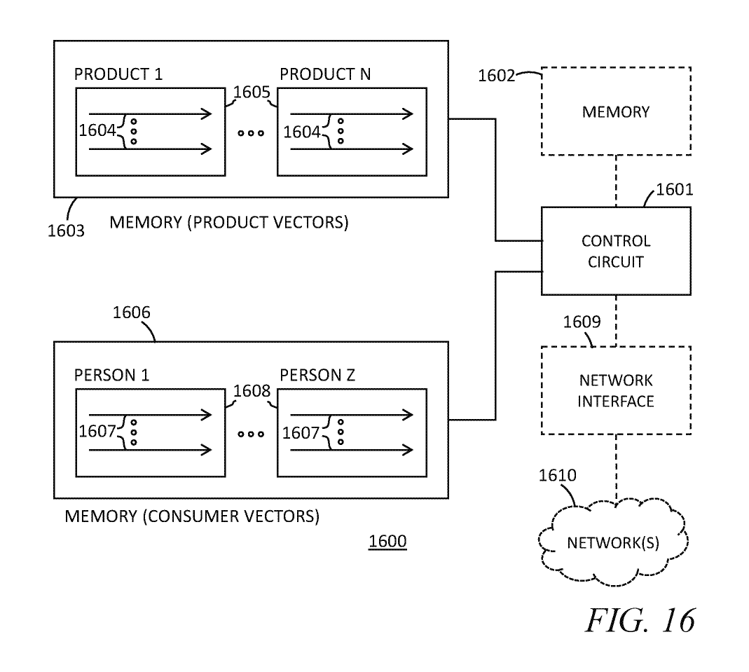

FIG. 16 presents an illustrative apparatus 1600 for conducting, containing, and utilizing the foregoing content and capabilities. In this particular example, the enabling apparatus 1600 includes a control circuit 1601. This control circuit 1601 can be the same as the control circuit 401 described above in FIG. 4 and can also be the same control circuit that carries out the process 100 described in FIG. 1.

In this example the control circuit 1601 operably couples to a memory 1602. This memory 1602 may be integral to the control circuit 1601 or can be physically discrete (in whole or in part) from the control circuit 1601 as desired. This memory 1602 can also be local with respect to the control circuit 1601 (where, for example, both share a common circuit board, chassis, power supply, and/or housing) or can be partially or wholly remote with respect to the control circuit 1601 (where, for example, the memory 1602 is physically located in another facility, metropolitan area, or even country as compared to the control circuit 1601).

This memory 1602 can serve, for example, to non-transitorily store the computer instructions that, when executed by the control circuit 1601, cause the control circuit 1601 to behave as described herein.

Either stored in this memory 1602 or, as illustrated, in a separate memory 1603 are the vectorized characterizations 1604 for each of a plurality of products 1605 (represented here by a first product through an Nth product where “N” is an integer greater than “1”). In addition, and again either stored in this memory 1602 or, as illustrated, in a separate memory 1606 are the vectorized characterizations 1607 for each of a plurality of individual persons 1608 (represented here by a first person through a Zth person wherein “Z” is also an integer greater than “1”) (such as the persons who are associated with the above-described user devices that source the above-described mobile analytics information)

In this example the control circuit 1601 also operably couples to a network interface 1609. So configured the control circuit 1601 can communicate with other elements (both within the apparatus 1600 and external thereto) via the network interface 1609. Network interfaces, including both wireless and non-wireless platforms, are well understood in the art and require no particular elaboration here. This network interface 1609 can compatibly communicate via whatever network or networks 1610 may be appropriate to suit the particular needs of a given application setting. Both communication networks and network interfaces are well understood areas of prior art endeavor and therefore no further elaboration will be provided here in those regards for the sake of brevity.

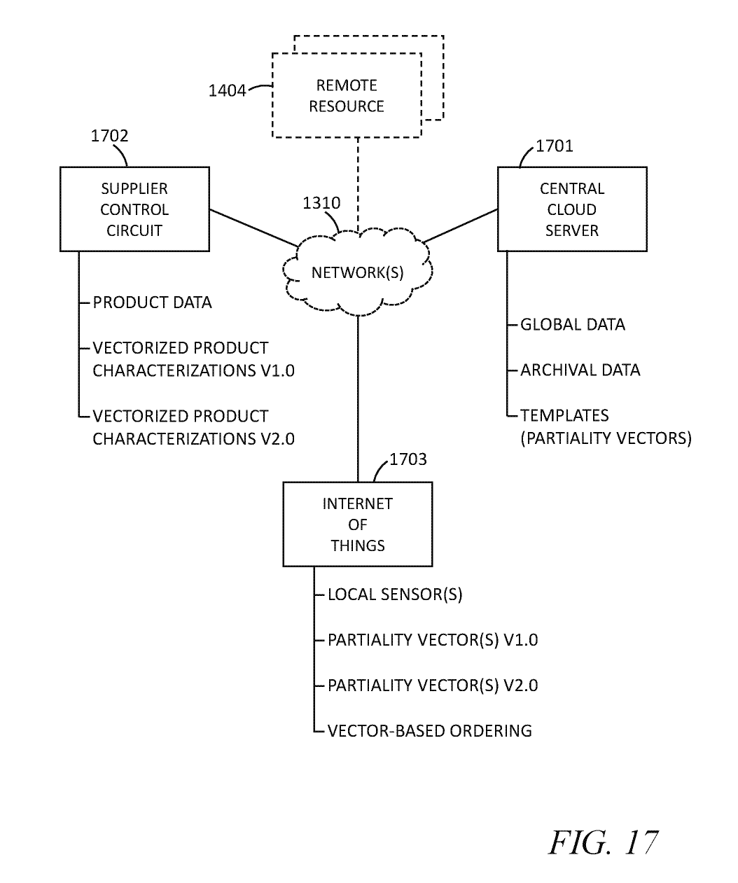

It will be appreciated that the apparatus 1600 described above can be viewed as a literal physical architecture or, if desired, as a logical construct. For example, these teachings can be enabled and operated in a highly centralized manner (as might be suggested when viewing that apparatus 1600 as a physical construct) or, conversely, can be enabled and operated in a highly decentralized manner. FIG. 17 provides an example as regards the latter.

In this illustrative example a central cloud server 1701, a supplier control circuit 1702, and the aforementioned Internet of Things 1703 communicate via the aforementioned network 1710.

The central cloud server 1701 can receive, store, and/or provide various kinds of global data (including, for example, general demographic information regarding people and places, profile information for individuals, product descriptions and reviews, and so forth), various kinds of archival data (including, for example, historical information regarding the aforementioned demographic and profile information and/or product descriptions and reviews), and partiality vector templates as described herein that can serve as starting point general characterizations for particular individuals as regards their partialities. Such information may constitute a public resource and/or a privately-curated and accessed resource as desired. (It will also be understood that there may be more than one such central cloud server 1701 that store identical, overlapping, or wholly distinct content.)

The supplier control circuit 1702 can comprise a resource that is owned and/or operated on behalf of the suppliers of one or more products (including but not limited to manufacturers, wholesalers, retailers, and even resellers of previously-owned products). This resource can receive, process and/or analyze, store, and/or provide various kinds of information. Examples include but are not limited to product data such as marketing and packaging content (including textual materials, still images, and audio-video content), operators and installers manuals, recall information, professional and non-professional reviews, and so forth.

Another example comprises vectorized product characterizations as described herein. More particularly, the stored and/or available information can include both prior vectorized product characterizations (denoted in FIG. 17 by the expression “vectorized product characterizations V1.0”) for a given product as well as subsequent, updated vectorized product characterizations (denoted in FIG. 17 by the expression “vectorized product characterizations V2.0”) for the same product. Such modifications may have been made by the supplier control circuit 1702 itself or may have been made in conjunction with or wholly by an external resource as desired.

As already noted above, the Internet of Things 1703 can comprise any of a variety of devices and components that may include local sensors that can provide information regarding a corresponding user's circumstances, behaviors, and reactions back to, for example, the aforementioned central cloud server 1701 and the supplier control circuit 1702 to facilitate the development of corresponding partiality vectors for that corresponding user. Again, however, these teachings will also support a decentralized approach.

For example, a so-called smart phone can itself include a suite of partiality vectors for a corresponding user and employ those partiality vectors to facilitate vector-based ordering (either automated or to supplement the ordering being undertaken by the user) as is otherwise described herein. In that case, the smart phone can obtain corresponding vectorized product characterizations from, for example, the aforementioned supplier control circuit 1702 can use that information in conjunction with local partiality vector information to facilitate the vector-based ordering.

Also, if desired, the smart phone in this example can itself modify and update partiality vectors for the corresponding user. To illustrate this idea in FIG. 17, this device can utilize, for example, information gained at least in part from local sensors to update a locally-stored partiality vector (represented in FIG. 17 by the expression “partiality vector V1.0”) to obtain an updated locally-stored partiality vector (represented in FIG. 17 by the expression “partiality vector V2.0”). Using this approach, a user's partiality vectors can be locally stored and utilized. Such an approach may better comport with a particular user's privacy concerns.

It will be understood that the smart phone employed in the immediate example is intended to serve in an illustrative capacity and is not intended to suggest any particular limitations in these regards. In fact, any of a wide variety of Internet of Things devices/components could be readily configured in the same regards. As one simple example in these regards, a computationally-capable networked refrigerator could be configured to order appropriate perishable items for a corresponding user as a function of that user's partialities.

Presuming a decentralized approach, these teachings will accommodate any of a variety of other remote resources 1704. These remote resources 1704 can, in turn, provide static or dynamic information and/or interaction opportunities or analytical capabilities that can be called upon by any of the above-described network elements. Examples include but are not limited to voice recognition, pattern and image recognition, facial recognition, statistical analysis, computational resources, encryption and decryption services, fraud and misrepresentation detection and prevention services, digital currency support, and so forth.

As already suggested above, these approaches provide powerful ways for identifying products and/or services that a given person, or a given group of persons, may likely wish to buy to the exclusion of other options. As one simple illustrative example, a person who exhibits a partiality for food products that emphasize health, natural ingredients, and a concern to minimize sugars and fats may be presumed to have a similar partiality for pet foods because such partialities may be based on a value system that extends beyond themselves to other living creatures within their sphere of concern. If other data is available to indicate that this person in fact has, for example, two pet dogs, these partialities can be used to identify dog food products having well-aligned vectors in these same regards. This person could then be solicited to purchase such dog food products using any of a variety of solicitation approaches (including but not limited to general informational advertisements, discount coupons or rebate offers, sales calls, free samples, and so forth).

As another simple example, the approaches described herein can be used to filter out products/services that are not likely to accord well with a given person's partiality vectors. In particular, rather than emphasizing one particular product over another, a given person can be presented with a group of products that are available to purchase where all of the vectors for the presented products align to at least some predetermined degree of alignment/accord and where products that do not meet this criterion are simply not presented.

And as yet another simple example, a particular person may have a strong partiality towards both cleanliness and orderliness. The strength of this partiality might be measured in part, for example, by the physical effort they exert by consistently and promptly cleaning their kitchen following meal preparation activities. If this person were looking for lawn care services, their partiality vector(s) in these regards could be used to identify lawn care services who make representations and/or who have a trustworthy reputation or record for doing a good job of cleaning up the debris that results when mowing a lawn. This person, in turn, will likely appreciate the reduced effort on their part required to locate such a service that can meaningfully contribute to their desired order.

These teachings can be leveraged in any number of other useful ways. As one example in these regards, various sensors and other inputs can serve to provide automatic updates regarding the events of a given person's day. By one approach, at least some of this information can serve to help inform the development of the aforementioned partiality vectors for such a person. At the same time, such information can help to build a view of a normal day for this particular person. That baseline information can then help detect when this person's day is going experientially awry (i.e., when their desired “order” is off track). Upon detecting such circumstances these teachings will accommodate employing the partiality and product vectors for such a person to help make suggestions (for example, for particular products or services) to help correct the day's order and/or to even effect automatically-engaged actions to correct the person's experienced order.

When this person's partiality (or relevant partialities) are based upon a particular aspiration, restoring (or otherwise contributing to) order to their situation could include, for example, identifying the order that would be needed for this person to achieve that aspiration. Upon detecting, (for example, based upon purchases, social media, or other relevant inputs) that this person is aspirating to be a gourmet chef, these teachings can provide for plotting a solution that would begin providing/offering additional products/services that would help this person move along a path of increasing how they order their lives towards being a gourmet chef.

By one approach, these teachings will accommodate presenting the consumer with choices that correspond to solutions that are intended and serve to test the true conviction of the consumer as to a particular aspiration. The reaction of the consumer to such test solutions can then further inform the system as to the confidence level that this consumer holds a particular aspiration with some genuine conviction. In particular, and as one example, that confidence can in turn influence the degree and/or direction of the consumer value vector(s) in the direction of that confirmed aspiration.

Referring again to FIG. 1, and as a very simple example, by using personalized mobile analytics information it can be known that a particular person is, for example, frequenting a particular retail shopping facility and by using the aforementioned partiality vectors for that particular person and the vectorized characterizations for the unsold resources, the control circuit can make decisions to ensure that this particular retail shopping facility is stocked with possibly unusual items that might well appeal to this particular person but which might not otherwise be stocked absent such insight.

To go further with this example, by knowing that a particular number of people who tend to frequent the retail shopping facility all have a shared (possibly somewhat less common) partiality, the aforementioned stocking can include not only those corresponding unusual items but also a quantity of such items as befits this number of people. In such a case these teachings will support using a plurality of partiality vectors that correspond to an aggregated group of users that also correspond to at least one of a point of origin (such as a given neighborhood, zip code, building, or the like) and a point of terminus (such as a restaurant, shopping center or mall, sporting venue, educational institution, place of employment, and so forth) as regards movement of their respective mobile devices.

These teachings are highly flexible in practice and will accommodate any number of approaches to leveraging the aforementioned data in these regards. By one approach, for example, the aforementioned unsold resources are resources that are offered by the same enterprise that also operates the aforementioned control circuit(s). By another approach the unsold resources are offered at retail by a third-party enterprise that does not also operate the aforementioned control circuit(s).

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

This application is related to, and incorporates herein by reference in its entirety, each of the following U.S. applications listed as follows by application number and filing date: 62/323,026 filed Apr. 15, 2016; 62/341,993 filed May 26, 2016; 62/348,444 filed Jun. 10, 2016; 62/350,312 filed Jun. 15, 2016; 62/350,315 filed Jun. 15, 2016; 62/351,467 filed Jun. 17, 2016; 62/351,463 filed Jun. 17, 2016; 62/352,858 filed Jun. 21, 2016; 62/356,387 filed Jun. 29, 2016; 62/356,374 filed Jun. 29, 2016; 62/356,439 filed Jun. 29, 2016; 62/356,375 filed Jun. 29, 2016; 62/358,287 filed Jul. 5, 2016; 62/360,356 filed Jul. 9, 2016; 62/360,629 filed Jul. 11, 2016; 62/365,047 filed Jul. 21, 2016; 62/367,299 filed Jul. 27, 2016; 62/370,853 filed Aug. 4, 2016; 62/370,848 filed Aug. 4, 2016; 62/377,298 filed Aug. 19, 2016; 62/377,113 filed Aug. 19, 2016; 62/380,036 filed Aug. 26, 2016; 62/381,793 filed Aug. 31, 2016; 62/395,053 filed Sep. 15, 2016; 62/397,455 filed Sep. 21, 2016; 62/400,302 filed Sep. 27, 2016; 62/402,068 filed Sep. 30, 2016; 62/402,164 filed Sep. 30, 2016; 62/402,195 filed Sep. 30, 2016; 62/402,651 filed Sep. 30, 2016; 62/402,692 filed Sep. 30, 2016; 62/402,711 filed Sep. 30, 2016; 62/406,487 filed Oct. 11, 2016; 62/408,736 filed Oct. 15, 2016; 62/409,008 filed Oct. 17, 2016; 62/410,155 filed Oct. 19, 2016; 62/413,312 filed Oct. 26, 2016; 62/413,304 filed Oct. 26, 2016; 62/413,487 filed Oct. 27, 2016; 62/422,837 filed Nov. 16, 2016; 62/423,906 filed Nov. 18, 2016; 62/424,661 filed Nov. 21, 2016; 62/427,478 filed Nov. 29, 2016; 62/436,842 filed Dec. 20, 2016; 62/436,885 filed Dec. 20, 2016; 62/436,791 filed Dec. 20, 2016; 62/439,526 filed Dec. 28, 2016; 62/442,631 filed Jan. 5, 2017; 62/445,552 filed Jan. 12, 2017; 62/463,103 filed Feb. 24, 2017; 62/465,932 filed Mar. 2, 2017; 62/467,546 filed Mar. 6, 2017; 62/467,968 filed Mar. 7, 2017; 62/467,999 filed Mar. 7, 2017; 62/471,089 filed Mar. 14, 2017; 62/471,804 filed Mar. 15, 2017; 62/471,830 filed Mar. 15, 2017; 62/479,106 filed Mar. 30, 2017; 62/479,525 filed Mar. 31, 2017; 62/480,733 filed Apr. 3, 2017; 62/482,863 filed Apr. 7, 2017; 62/482,855 filed Apr. 7, 2017; 62/485,045 filed Apr. 13, 2017; Ser. No. 15/487,760 filed Apr. 14, 2017; Ser. No. 15/487,538 filed Apr. 14, 2017; Ser. No. 15/487,775 filed Apr. 14, 2017; Ser. No. 15/488,107 filed Apr. 14, 2017; Ser. No. 15/488,015 filed Apr. 14, 2017; Ser. No. 15/487,728 filed Apr. 14, 2017; Ser. No. 15/487,882 filed Apr. 14, 2017; Ser. No. 15/487,826 filed Apr. 14, 2017; Ser. No. 15/487,792 filed Apr. 14, 2017; Ser. No. 15/488,004 filed Apr. 14, 2017; Ser. No. 15/487,894 filed Apr. 14, 2017; 62/486,801 filed Apr. 18, 2017; 62/491,455 filed Apr. 28, 2018; 62/502,870 filed May 8, 2017; 62/510,322 filed May 24, 2017; 62/510,317 filed May 24, 2017; Ser. No. 15/606,602 filed May 26, 2017; 62/511,559 filed May 26, 2017; 62/513,490 filed Jun. 1, 2017; 62/515,675 filed Jun. 6, 2018; Ser. No. 15/624,030 filed Jun. 15, 2017; Ser. No. 15/625,599 filed Jun. 16, 2017; Ser. No. 15/628,282 filed Jun. 20, 2017; 62/523,148 filed Jun. 21, 2017; 62/525,304 filed Jun. 27, 2017; Ser. No. 15/634,862 filed Jun. 27, 2017; 62/527,445 filed Jun. 30, 2017; Ser. No. 15/655,339 filed Jul. 20, 2017; Ser. No. 15/669,546 filed Aug. 4, 2017; and 62/542,664 filed Aug. 8, 2017; 62/542,896 filed Aug. 9, 2017; Ser. No. 15/678,608 filed Aug. 16, 2017; 62/548,503 filed Aug. 22, 2017; 62/549,484 filed Aug. 24, 2017; Ser. No. 15/685,981 filed Aug. 24, 2017; 62/558,420 filed Sep. 14, 2017; Ser. No. 15/704,878 filed Sep. 14, 2017; 62/559,128 filed Sep. 15, 2017; Ser. No. 15/783,787 filed Oct. 13, 2017; Ser. No. 15/783,929 filed Oct. 13, 2017; Ser. No. 15/783,825 filed Oct. 13, 2017; Ser. No. 15/783,551 filed Oct. 13, 2017; Ser. No. 15/783,645 filed Oct. 13, 2017; Ser. No. 15/782,555 filed Oct. 13, 2017; 62/571,867 filed Oct. 13, 2017; Ser. No. 15/783,668 filed Oct. 13, 2017; Ser. No. 15/783,960 filed Oct. 13, 2017; and Ser. No. 15/782,559 filed Oct. 13, 2017.

What is claimed is:

1. An apparatus comprising:
a control circuit configured to:
access mobile analytics information comprising, at least in part, data regarding movement of user devices;
use the data regarding movement of user devices in conjunction with corresponding rules to facilitate allocating unsold resources.

2. The apparatus of claim 1 wherein the data regarding movement of user devices constitutes anonymized information that does not identify specific users.

3. The apparatus of claim 2 wherein the control circuit is further configured to:
personalize the anonymized information to thereby provide data regarding movement of specifically-identified users;
and wherein the control circuit is configured to use the data regarding movement of user devices to facilitate allocating unsold resources by, at least in part, using the data regarding movement of specifically-identified users to facilitate allocating the unsold resources.

4. The apparatus of claim 1 wherein the unsold resources comprise goods.

5. The apparatus of claim 4 wherein the control circuit is configured to use the data regarding movement of user devices to facilitate allocating unsold resources by, at least in part, controlling inventory of the goods at a retail shopping facility as a function of the data regarding movement of user devices.

6. The apparatus of claim 4 wherein the control circuit is configured to use the data regarding movement of user devices to facilitate allocating unsold resources by, at least in part, controlling physical movement of the goods as a function of the data regarding movement of user devices.

7. The apparatus of claim 6 wherein the control circuit is configured to control the physical movement of the goods by, at least in part, selectively controlling physical movement of the goods to thereby increase customer accessibility to the goods.

8. The apparatus of claim 1 wherein the unsold resources comprise services.

9. The apparatus of claim 1 wherein the control circuit is configured to use the data regarding movement of user devices to facilitate allocating unsold resources by, at least in part, making allocation decisions regarding the unsold resources as a function, at least in part, of points of origin for the movement of the user devices.

10. The apparatus of claim 1 wherein the control circuit is configured to use the data regarding movement of user devices to facilitate allocating unsold resources by, at least in part, making allocation decisions regarding the unsold resources as a function, at least in part, of points of terminus for the movement of the user devices.

11. The apparatus of claim 1 wherein the control circuit is configured to use the data regarding movement of user devices to facilitate allocating unsold resources by, at least in part, making allocation decisions regarding the unsold resources as a function, at least in part, of both points of origin and points of terminus for the movement of the user devices.

12. The apparatus of claim 1 wherein the unsold resources comprise resources offered by an enterprise that also operates the control circuit.

13. The apparatus of claim 1 wherein the unsold resources comprise resources offered by a third-party enterprise that does not also operate the control circuit.

14. The apparatus of claim 1 wherein the data regarding movement of user devices comprises, at least in part, real-time data regarding movement of the user devices.

15. The apparatus of claim 1 wherein the control circuit is configured to:
characterize user behavior as a function of the data regarding movement of user devices;
and wherein the control circuit is configured to facilitate allocating the unsold resources, at least in part, by influencing a supply chain for the unsold resources as a function of the characterized user behavior.

16. The apparatus of claim 1 wherein the control circuit is further configured to:
access information including a plurality of partiality vectors for at least some users of the user devices and vectorized characterizations for each of at least some of the unsold resources, wherein each of the vectorized characterizations indicates a measure regarding an extent to which a corresponding one of the unsold resources accords with a corresponding one of the plurality of partiality vectors.

17. The apparatus of claim 16 wherein at least some of the plurality of partiality vectors correspond to an aggregated group of users that correspond to at least one of a point of origin and a point of terminus as regards movement of the user devices.

18. The apparatus of claim 16 wherein at least some of the plurality of partiality vectors correspond to individual ones of the users.

19. The apparatus of claim 16 wherein the control circuit is configured to use the data regarding movement of the user devices to facilitate allocating unsold resources by, at least in part, also using the plurality of partiality vectors for at least some users of the user devices and the vectorized characterizations for each of at least some of the unsold resources to facilitate allocating the unsold resources.
